(19) United States
(12) Patent Application Publication
(10) Pub. No.: US 2025/0336042 A1
(43) Pub. Date: Oct. 30, 2025

(54) LIGHTWEIGHT IMAGE RESTORATION

(71) Applicant: SAMSUNG ELECTRONICS CO., LTD., Suwon-si (KR)

(72) Inventors: Raj Narayana GADDE, Bengaluru (IN); Addanki Sankara RAO, Bengaluru (IN); Pravin Ramachandran NAIR, Bengaluru (IN); Sarvesh, Bengaluru (IN); Siddharth Shreekumar SHARMA, Bengaluru (IN); Yathish REDDY, Bengaluru (IN)

(73) Assignee: SAMSUNG ELECTRONICS CO., LTD., Suwon-si (KR)

(21) Appl. No.: 19/184,394

(22) Filed: Apr. 21, 2025

Related U.S. Application Data
(63) Continuation of application No. PCT/KR2025/003536, filed on Mar. 18, 2025.

(30) Foreign Application Priority Data
Apr. 24, 2024 (IN) 202441032586
Dec. 5, 2024 (IN) 202441032586

(51) Int. Cl. G06T 5/60; G06T 5/70; G06T 5/73

(52) U.S. Cl. CPC G06T 5/60; G06T 5/70; G06T 5/73; G06T 2207/20221

(57) ABSTRACT

A method for lightweight image restoration is provided. The method includes receiving an input image of a scene captured at a pre-defined zoom level by an imaging sensor of the electronic device; inputting the input image into a naturalness restoration model to obtain a naturalness restored image and restored natural characteristics of the scene; inputting the input image into a texture enhancement model to obtain a texture enhanced image and enhanced texture characteristics of the scene; inputting the restored natural characteristics of the scene, the enhanced texture characteristics of the scene, and the input image into an image restoration model to obtain an intermediate enhanced image corresponding to the input image; and generating, using a fusion unit, an output image that is an enhanced version of the input image based on the intermediate enhanced image, the naturalness restored image, and the texture enhanced image.

### CROSS-REFERENCE TO RELATED APPLICATIONS

This application is a continuation of International Application No. PCT/KR2025/003536, filed on Mar. 18, 2025, at the Korean Intellectual Property Office, which claims priority from Indian patent application Ser. No. 202441032586 filed on Apr. 24, 2024, and from Indian patent application Ser. No. 202441032586, filed on Dec. 5, 2024, the contents of which are incorporated herein by reference herein in their entireties.

### FIELD

This application relates to image enhancement techniques. More particularly, present disclosure relates to lightweight image restoration image enhancement/restoration solution for high-scale zoom capabilities.

### BACKGROUND

The pursuit of enhanced image quality has been a central objective in electronic image reproduction, evolving from the era of black-and-white television to the present day with advanced high-definition flat-screen displays. The imaging systems includes cameras that has ability to zoom which allows the system to transition smoothly between wide-angle and close-up shots, effectively altering the perceived angle of view in digital photographs or videos. However, digital zoom, particularly in mobile camera systems, encounters significant challenges, especially at high zoom levels like 50× or 100×.

One of the primary issues with digital zoom in mobile devices is the substantial degradation of image quality. Most mobile cameras are equipped with fixed lenses that inherently capture limited detail when zoomed in, as they achieve zoom by cropping the central portion of the image. This results in a noticeable reduction in pixel density, causing small details and textures to become indistinct. Consequently, the output images often appear flat and grainy, lacking the natural texture and sharpness that are characteristic of high-quality photographs.

To address these challenges, generative solutions such as Generative Adversarial Networks (GANs), Diffusion models, or complex discriminative models have been developed. While these solutions can improve image quality to some extent, they introduce their own set of problems. These methods typically require substantial processing time and can generate unrealistic artifacts, rendering them unsuitable for real-time image capture applications. Additionally, these generative models necessitate separate training for different lenses, as each lens introduces unique blur and noise characteristics, further complicating their deployment in real-world scenarios.

Current solutions also struggle to preserve intricate features such as fine details, textures, and color tones, all of which are used for maintaining the overall quality of enhanced images. Lightweight models, while faster, lack the resolution power to effectively distinguish between noise and details, leading to further loss of texture and clarity. Conversely, complex generative models, although capable of producing detailed images, often create artifacts that were not present in the original image. These models also require retraining when sensor or lens characteristics change, making them impractical for real-time applications in user devices.

The primary issue with existing solutions is the loss of detail and texture, which results in images that appear artificially “painted” rather than natural. Therefore, there is a need to address these disadvantages or other shortcomings, or at least provide a viable alternative that can enhance image quality while maintaining the natural appearance of photographs.

### SUMMARY

In an aspect, a method for lightweight image restoration is provided. The method includes receiving an input image of a scene captured at a pre-defined zoom level by an imaging sensor of the electronic device; inputting the input image into a naturalness restoration model to obtain a naturalness restored image and restored natural characteristics of the scene; inputting the input image into a texture enhancement model to obtain a texture enhanced image and enhanced texture characteristics of the scene; inputting the restored natural characteristics of the scene, the enhanced texture characteristics of the scene, and the input image into an image restoration model to obtain an intermediate enhanced image corresponding to the input image; and generating, by using a fusion unit, an output image that is an enhanced version of the input image based on the intermediate enhanced image, the naturalness restored image, and the texture enhanced image.

In an aspect, an electronic device for enhancing captured images by using an imaging sensor is provided. The electronic device includes memory, at least one processor coupled to the memory, and a lightweight image restoration controller coupled to the processor. The lightweight image restoration controller is configured to receive an input image of a scene captured at a pre-defined zoom level by an imaging sensor of the electronic device; input the received input image into a naturalness restoration model to obtain a naturalness restored image, and restored natural characteristics of the scene; input the input image into a texture enhancement model to obtain a texture enhanced image, and enhanced texture characteristics of the scene; input the restored natural characteristics of the scene, the enhanced texture characteristics of the scene, and the input image into an generic Image restoration model to obtain an intermediate enhanced image corresponding to the input image; and generate, by using a fusion unit, an output image that is an enhanced version of the input image based on the intermediate enhanced image, the naturalness restored image, and the texture enhanced image.

In an aspect, a non-transitory computer-readable medium storing one or more instructions is provided. The one or more instructions, when executed by at least one processor, cause the at least one processor to: receive an input image of a scene captured at a pre-defined zoom level by an imaging sensor of the electronic device; input the received input image into a naturalness restoration model to obtain a naturalness restored image, and restored natural characteristics of the scene; input the input image into a texture enhancement model to obtain a texture enhanced image, and enhanced texture characteristics of the scene; input the restored natural characteristics of the scene, the enhanced texture characteristics of the scene, and the input image into an generic Image restoration model to obtain an intermediate enhanced image corresponding to the input image; and generate, by using a fusion unit, an output image that is an enhanced version of the input image based on the intermediate enhanced image, the naturalness restored image, and the texture enhanced image.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications be made within the scope of the embodiments herein.

### BRIEF DESCRIPTION OF DRAWINGS

These and other features, aspects, and advantages of the present embodiments are illustrated in the accompanying drawings, throughout which like reference letters indicate corresponding parts in the various figures. The embodiments herein will be better understood from the following description with reference to the drawings, in which:

FIG. 1A and FIG. 1B illustrate an example of high-scale zoom restored images and an original image in the context of naturalness according to related art.

FIG. 2A and FIG. 2B illustrate an example of high-scale zoom restored images and an original image in the context of texture according to related art.

FIG. 3 is a block diagram of an electronic device for lightweight image restoration according to the embodiment disclosed herein.

FIG. 4 is a block diagram of a lightweight high texture image restoration using a pre-trained texture and naturalness prior according to the embodiment disclosed herein.

FIG. 5 is a block diagram that illustrates the working operation of a naturalness restoration model according to the embodiment disclosed herein.

FIG. 6A and FIG. 6B illustrate an example for understanding image restoration property in terms of naturalness according to the embodiment disclosed herein.

FIG. 7A and FIG. 7B illustrate an example for understanding image restoration properties, specifically focusing on selective noise retention and removal according to the embodiment disclosed herein.

FIG. 8 is a block diagram that illustrates the output of the naturalness restoration model using an input image according to the embodiment disclosed herein.

FIG. 9 is a block diagram that illustrates the working operation of the texture enhancement model according to the embodiment disclosed herein.

FIG. 10A and FIG. 10B illustrate an example of understanding image restoration property in terms of texture according to the embodiment disclosed herein.

FIG. 11A and FIG. 11B illustrate an example of understanding image restoration property in terms of texture according to the embodiment disclosed herein.

FIG. 12 is a block diagram that illustrates an output image of the texture enhancement model using an input image according to the embodiment disclosed herein.

FIG. 13 is a block diagram that illustrates the working of a lightweight image restoration model according to the embodiment disclosed herein.

FIG. 14A and FIG. 14B are block diagrams that illustrate the working of a fusion unit according to the embodiment disclosed herein.

FIG. 15A-15D illustrate various stages of the texture image enhancement process to get the final output according to the embodiment disclosed herein.

FIG. 16A-16D illustrate various stages of the naturalness enhancement process to obtain the final output according to the embodiment disclosed herein.

FIG. 17 is a block diagram that illustrates the training strategy of the lightweight image restoration by an electronic device according to the embodiment disclosed herein.

FIG. 18A and FIG. 18B illustrate the comparison between the input image and output image of the proposed model according to the embodiment disclosed herein.

FIG. 19A and FIG. 19B illustrate the comparison between the input image and output of the proposed model according to the embodiment disclosed herein.

FIG. 20A and FIG. 20B illustrate the comparison between the input image and output of the proposed model according to the embodiment disclosed herein.

FIG. 21 is a flowchart that illustrates the working of the proposed model according to the embodiment disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and further enable those skilled in the art to practice the embodiments herein. Accordingly, the examples are not be construed as limiting the scope of the embodiments herein.

As is existing in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the present disclosure is construed to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

Embodiments are directed to providing a lightweight image restoration solution.

Embodiments are directed to restoring a natural appearance in digital images that involves enhancing surface patterns, maintaining tone, and selectively restoring sensor noise patterns. By utilizing a naturalness restoration model, the image is restored to enhance naturalness and maintain a realistic look.

Embodiments are directed to enhancing textures like fine contours, striations, and intricate details in digital images. This emphasizes retaining and boosting these features while reducing noise and sensor-induced artifacts, thus improving image clarity and structure.

Embodiments are directed to providing a lightweight image restoration engine that integrates features from a naturalness restoration and a texture enhancement method. This model prioritizes areas of the image needing specific improvements based on pre-trained priors, effectively guiding the enhancement mechanism.

Embodiments are directed to combining the outputs from the naturalness restoration method, texture enhancement method, and the lightweight image restoration model. The combination weights are learned dynamically to optimize the blend of enhanced images produced by the naturalness and texture models. This technique ensures that a final image output maintains balance between enhanced texture and naturalness, leading to a more realistic and visually pleasing result.

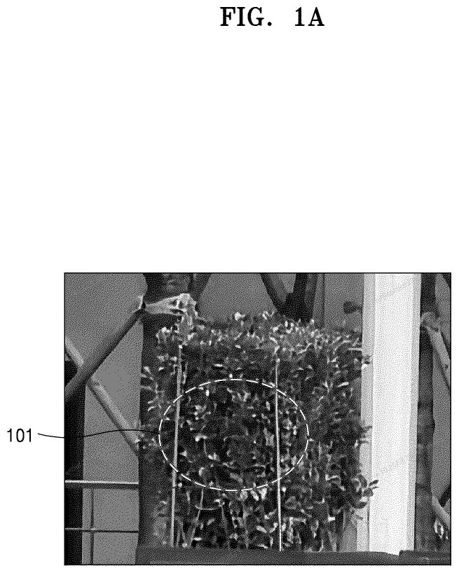

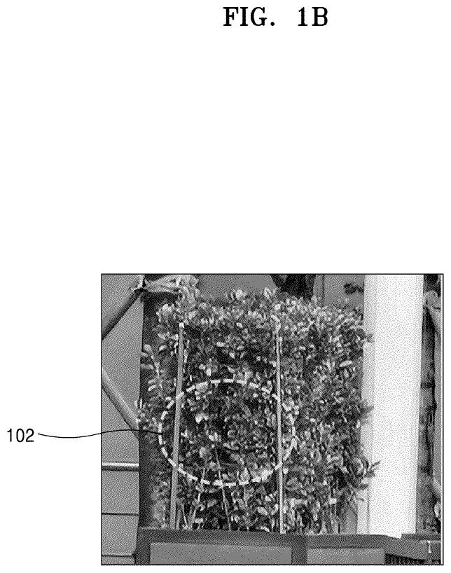

FIG. 1A and FIG. 1B illustrates the example of high-scale zoom restored images and the original image in the context of naturalness, according to related art. FIG. 1A depicts high-scale zoom restored images of a plant using discriminative and generative models. These models fail to capture the naturalness necessary for preserving fine details and small leaves (101) present in the original image. Consequently, there is a significant loss of finer details in small leaves (103), resulting in images that appear unnatural and paint-like. In contrast, the FIG. 1B illustrates a close-up capture of the plant, effectively capturing intricate details, including small leaves and textures (102), which are not preserved in the FIG. 1A. This image demonstrates the clarity and detail achievable when capturing at a closer distance. However, the images in the FIG. 1A and FIG. 1B highlight the challenges faced in applications such as denoising and super-resolution.

The need for advanced techniques to preserve texture and naturalness during image restoration is underscored by the FIG. 1A. This requirement has led to the adoption of deep neural networks as discriminative models or the use of computationally intensive generative models. Despite their potential, the complexity associated with these approaches limits the effectiveness of lightweight real-time learning solutions on mobile devices, compromising their ability to maintain finer details and textures while achieving their intended functionalities.

Moreover, there is a lack of adaptability of these models across different camera sensors. Lens characteristics vary depending on the sensor used, resulting in variations in noise and blur characteristics. Consequently, existing models primarily rely on variations in input data, necessitating retraining and validation from scratch for every change in sensor. Existing methods for image restoration applications, such as denoising, deblurring, and super-resolution, typically utilize one of two approaches. Discriminative methods often involve lightweight deep neural network (DNN) models that may be deployed on devices for near-real-time camera ISP use cases. However, these models frequently suffer from low resolution, loss of detail and texture, and result in images that appear unnatural or paint-like. In contrast, more complex model architectures may preserve details and textures but are unsuitable for near-real-time applications due to high latency.

Furthermore, existing methods require complete retraining to adapt to changes in image sensors, leading to increased turnaround time. Generative methods require complex models that cannot be used for near-real-time camera ISP use cases. These generative models tend to introduce artifacts that may not be present in real-world scenes, further complicating the restoration process.

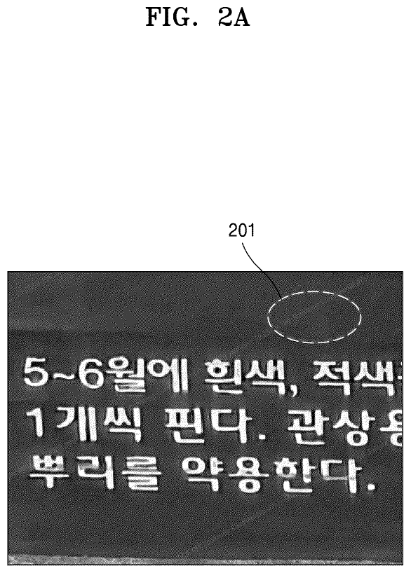

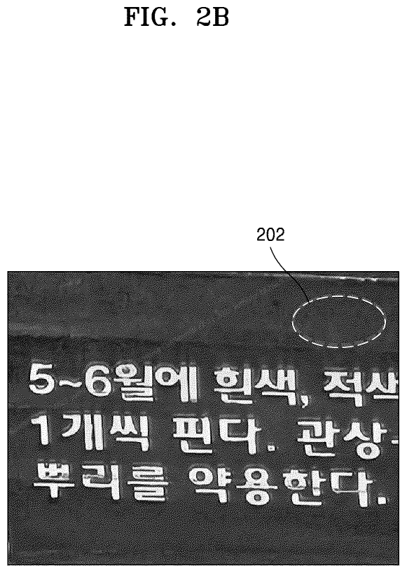

The present invention addresses the limitations of related art in image restoration, as illustrated in FIG. 2A and FIG. 2B. FIG. 2A depicts high-scale zoom restored images captured using lightweight image restoration models applied to a name board. These models are designed for efficiency, enabling real-time processing suitable for mobile devices. The primary focus of these models is on denoising and deblurring, which are used for enhancing image clarity. However, they often result in a significant loss of texture and detail (201), struggling to effectively distinguish between noise and important image features. This leads to a detrimental effect on the image, with the output often appearing oversimplified and filled with artifacts, as shown in FIG. 2A.

In contrast, FIG. 2B illustrates the original image of the name board, captured at a close-up view. This figure reveals the intricate details, textures, and natural appearance (202) that are absent in the processed image. The comparison between FIG. 2A and FIG. 2B highlights the limitations of lightweight restoration models in preserving the richness and complexity of real-world scenes.

The proposed invention introduces a lightweight, real-time method for image restoration that utilizes texture and naturalness priors. This invention enables high-quality camera capture for faraway shots, ranging from 10× to 100×zoom, in various devices. Images captured at defined zoom levels exhibit better texture detail retention, reduce grainy sensor noise, and provide a natural scene tone, along with enhanced resolution, deblurring, and noise reduction. The invention enhances defined zoom images through a novel pipeline that restores the naturalness and texture of the scene, while simultaneously improving resolution, deblurring, and noise reduction.

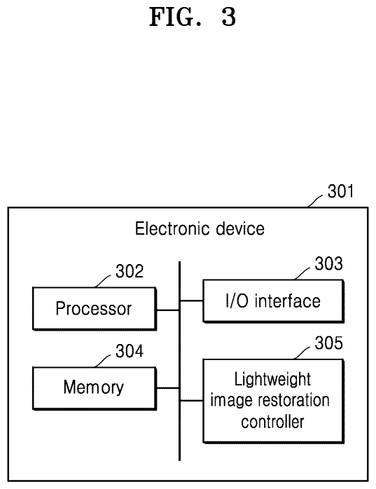

FIG. 3 is the block diagram illustrating the electronic device according to the embodiment disclosed herein. The electronic device (301) includes a processor (302), an input/output (I/O) interface (303), a memory (304), and a lightweight image restoration controller (305). For example, the electronic device (301) can include, but is not limited to, a mobile phone, a smartphone, tablets, laptops, Internet of Things (IoT) devices. Further, the processor (302) of the electronic device (301) communicates with the memory (304), the I/O interface (303), and the lightweight image restoration controller (305). The processor (302) is configured to execute instructions stored in the memory (304) and to perform various processes. The processor (302) may include processing circuitry. The processor (302) can include one or a plurality of processors, and one or more processors included in the processor (302) may execute one or more instructions stored in the memory (304) individually or collectively, thereby cause the electronic device (301) may perform any combination of operations, steps, and/or functions described herein. The processor (302) can be a general-purpose processor such as a central processing unit (CPU), an application processor (AP), or the like, a graphics-only processing unit such as a graphics processing unit (GPU), a visual processing unit (VPU), or the like, and/or an artificial intelligence (AI) dedicated processor such as a neural processing unit (NPU).

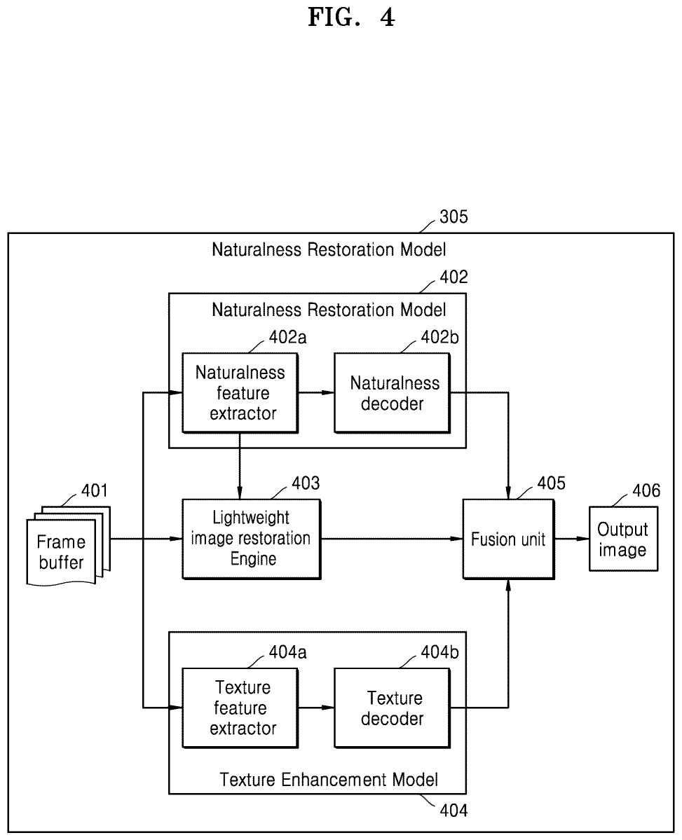

Further, the memory (304) of the electronic device (301) includes one or more storage locations to be addressable through the processor (302). The memory (304) is not limited to a volatile memory and/or a non-volatile memory. Further, the memory (304) can include one or more computer-readable storage media. The memory (304) can include non-volatile storage elements. For example, non-volatile storage elements can include magnetic hard disks, optical disks, floppy disks, flash memories, or forms of electrically programmable memories (EPROM) or electrically erasable and programmable (EEPROM) memories. The memory (304) stores the input images and restored output image obtained from one or models for the electronic device (301) (e.g., a natural restoration model (402), a texture enhancement model (404), and/or an image restoration model included in a lightweight image restoration engine (403) of FIG. 4).

The I/O interface (303) transmits the information between the memory (304), electronic device (301), and external peripheral devices. The peripheral devices are the input-output devices associated with the electronic device (301). The lightweight image restoration controller (305) communicates with the I/O interface (303) and memory (304) for enhancing captured images by using an imaging sensor. The lightweight image restoration controller (305) may be a hardware unit that is realized through the physical implementation of both analog and digital circuits, including logic gates, integrated circuits, microprocessors, microcontrollers, memory circuits, passive and active electronic components, as well as optical components. Also, the lightweight image restoration controller (305) is realized through the physical implementation of both analog and digital circuits, including logic gates, integrated circuits, microprocessors, microcontrollers, memory circuits, passive and active electronic components, as well as optical components. The I/O interface (303) sends and receives the input images and restored output image from one or models for the electronic device (301) (e.g., the natural restoration model (402), the texture enhancement model (404), and/or the image restoration model included in the lightweight image restoration engine (403) of FIG. 4) for further processing.

The lightweight image restoration controller (305) receives an input image (e.g., an input image included (or stored) in a frame buffer (401) of FIG. 4) of a scene captured at a defined zoom level by the imaging sensor of the electronic device (301). The imaging sensor is equipped with advanced pixel architecture to capture high-resolution images even at significant zoom levels, ensuring minimal loss of detail. Further, the lightweight image restoration controller (305) inputs the received input image into a neural network model (e.g., the naturalness restoration model (402) of FIG. 4) to obtain a naturalness restored image (e.g., an output frame of FIG. 4) and one or more restored natural characteristics of the scene (e.g., one or more feature maps (1003) of FIG. 4). In embodiments, the lightweight image restoration controller (305), in conjunction with processor (302) and memory (304), obtains a pre-trained naturalness restoration model, such as the naturalness restoration model (402) of FIG. 4. The naturalness restoration model according to an embodiment of the present disclosure utilizes a deep learning framework that incorporates a series of convolutional layers designed to analyze and enhance color balance, contrast, selective denoising, improved tone and dynamic range.

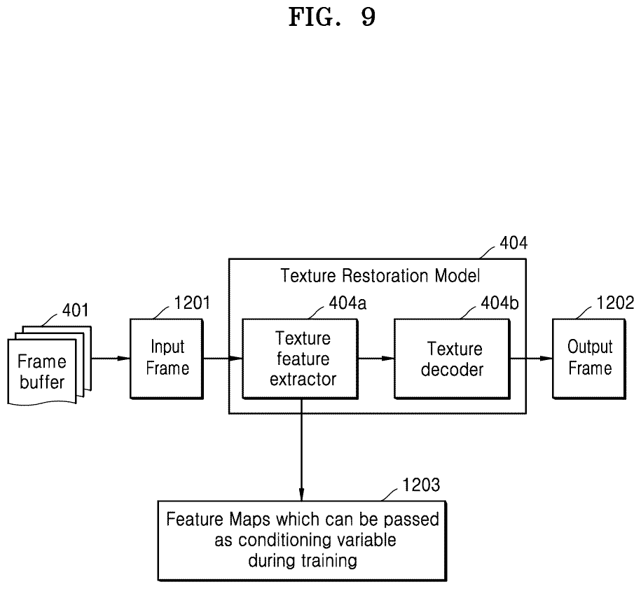

Further, the lightweight image restoration controller (305) inputs the input image into a neural network model (e.g., the texture enhancement model (404) of FIG. 4) to obtain a texture enhanced image (e.g., an output frame (1202) of FIG. 9) and one or more enhanced texture characteristics of the scene (e.g., one or more feature maps (1203) of FIG. 9). In embodiments, the lightweight image restoration controller (305), in conjunction with processor (302) and memory (304), obtains a pre-trained texture enhancement model, such as the texture enhancement model (404). The texture enhancement model (404) employs a multi-scale approach to detect and amplify fine textures and patterns, ensuring that the enhanced image retains a realistic appearance.

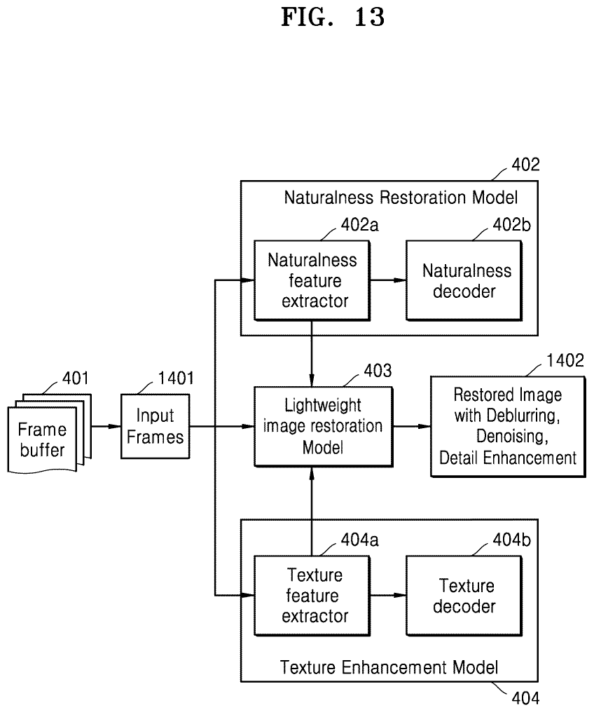

Further, the lightweight image restoration controller (305) inputs the restored natural characteristics of the scene, the enhanced texture characteristics of the scene, and the input image into the image restoration model to obtain an intermediate enhanced image (e.g., an intermediate enhanced image (1402) of FIG. 13) corresponding to the input image. In embodiments, the lightweight image restoration controller (305), in conjunction with processor (302) and memory (304), obtains a pre-trained Image restoration model, such as the image restoration model. In an embodiment, the image restoration model may be included in an image restoration engine (e.g., the lightweight image restoration engine (403) of FIG. 4). The image restoration model integrates features from both the naturalness and texture models, using a fusion algorithm that prioritizes image fidelity and detail preservation. Further, the lightweight image restoration controller (305) generates an output image (e.g., the output image (406) of FIG. 4) enhanced over the input image based on the intermediate enhanced image, the naturalness restored image, and the texture enhanced image. The output image is optimized for visual clarity and aesthetic appeal, making it suitable for both professional and consumer applications.

In embodiments, the lightweight image restoration controller (305) trains the texture enhancement model. The lightweight image restoration controller (305) may also obtain the texture enhancement model subsequent to the training of the texture enhancement model. The training involves inputting the pair of images into the lightweight neural network architecture. This architecture is specifically designed to handle high-dimensional data efficiently, reducing computational load while maintaining accuracy. The pair of images includes training images and the texture enhanced image generated using proprietary filters to highlight and improve specific textural attributes in the training image. These filters are fine-tuned to enhance micro-contrast and edge sharpness, which are used for texture perception. The lightweight neural network architecture includes a plurality of convolutional layers with varying spatial dimensions and depths to process the training image. These layers are configured to capture both global and local texture features, ensuring comprehensive enhancement. The neural network is trained, for example, by the lightweight image restoration controller (305), using the pair of images, the set of filters, and the naturalness restoration model dataset. The set of filters are configured to maintain the style and the pixel-level accuracy in the output image. The neural network learns through multiple learning iterations, adjusting weights and biases to optimize texture enhancement. The neural network enhances textures in the pair of images. The enhanced textures exhibit an improved level of pattern regularity, the level of fine detail coarseness, and the level of surface roughness. This results in images that are visually appealing and rich in detail and depth.

In embodiments, lightweight image restoration controller (305) creates the naturalness restoration model dataset by capturing the images. The lightweight image restoration controller (305) could obtain the naturalness restoration model dataset. The images are captured using the specific camera sensor intended for deployment of the naturalness restoration model (402), thereby ensuring sensor specificity. This approach allows the model to account for unique sensor characteristics such as color response and noise profile. The creation may include applying proprietary filters to the captured training images. These filters are designed to simulate various environmental conditions, such as different lighting scenarios and atmospheric effects, to enhance the robustness of the model. The proprietary filters are configured to perform selective denoising on the training images to reduce noise while preserving image detail. Further, it enhances natural grain in the images to retain characteristics specific to the imaging sensor of the electronic device (301) and improve overall detail and clarity of the images. The lightweight image restoration controller (305) generates or obtains the generated dataset. The dataset involves the processed images with enhanced naturalness elements suitable for use in training or deploying the naturalness restoration model specific to the imaging sensor of the electronic device (301). This dataset serves as a comprehensive training resource, enabling the model to deliver performance across a wide range of scenarios.

The lightweight image restoration controller (305) trains the texture enhancement model. In embodiments, the lightweight image restoration controller (305) may also obtain the texture enhancement model (404) subsequent to its training. The training involves inputting the pair of images into the lightweight neural network architecture. This architecture is optimized for rapid convergence and overfitting, ensuring efficient training cycles. The pair of images includes the input images from the sensor and the naturalness enhanced image. The lightweight neural network includes a plurality of convolutional layers with varying spatial dimensions and depths to process training images. These layers are adept at capturing subtle variations in color, sensor noise and light, which are used for naturalness restoration. The training of the neural network is performed using the pair of images, the set of filters, and the texture enhancement model dataset. The set of filters are configured to maintain the style and the pixel-level accuracy in the output image. The neural network learns through multiple learning iterations, refining its ability to enhance naturalness features. The neural network enhances naturalness features in the pair of images. The naturalness features include color fidelity, the level of lighting accuracy, and the level of controlled noise patterns. This results in images that are visually pleasing and true to the original scene.

The lightweight image restoration controller (305) creates the texture enhancement model dataset. In embodiments, the lightweight image restoration controller (305) obtains the texture enhancement model dataset. The generation of the texture enhancement model dataset includes obtaining the training images. These images are selected to cover a wide range of textures and patterns, providing a diverse training set. The training images are captured by the specific camera sensor for which the texture enhancement model is to be deployed. This ensures that the model is finely tuned to the sensor's capabilities and limitations. The set of filters is applied to the training images. The set of filters are configured to improve the regularity and directionality of patterns in the images, increase the frequency and coarseness of existing fine details of the training images, and enhance the level of surface roughness of the training images. These filters are designed to mimic the effects of various environmental conditions, such as wind or water, on texture. The enhanced texture enhanced images from the training images are generated based on the output from the set of filters. The output is generated by the texture enhanced images for processing or display. These images serve as a benchmark for evaluating the performance of the texture enhancement model.

The lightweight image restoration controller (305) trains the image restoration model. In embodiments, the lightweight image restoration controller (305) obtains the image restoration model subsequent to the training of the image restoration model. The training involves generating degraded versions of training images by passing the training images through a synthetic degradation pipeline. This pipeline is designed to simulate a wide range of real-world conditions, such as low light or motion blur, to enhance the model's adaptability. The synthetic degradation pipeline is created by randomly varying degradation parameters to simulate real-world degradation scenarios. The degradation parameters include denoising operations, deblurring operations, super-resolution operations, and enhancement tasks operations. These operations are carefully calibrated to ensure that the degraded images closely resemble those captured in challenging conditions. The the degraded versions of the training images are mapped with corresponding enhanced counterparts to form the training dataset for the image restoration model. This mapping process is used for training the model to recognize and correct various types of image degradation. The feature maps obtained from the attention-based convolutional neural network (CNN) are fused with output features or images obtained from the naturalness restoration model (402) and the texture enhancement model (404). This fusion process leverages the strengths of each model, resulting in a comprehensive restoration solution.

The electronic device (301) inputs the input image into the naturalness restoration model to obtain the naturalness restored image. The restored natural characteristics of the scene include extracted, using the naturalness restoration model, feature maps from the input image. These feature maps are rich in detail, capturing subtle variations in color, sensor noise characteristics and light that are used for naturalness restoration. The feature maps include the restored natural characteristics and information regarding one of sensor noise characteristics, lighting and shadow accuracy, and color fidelity. The electronic device (301) applies targeted corrections in the input image for noise reduction, lighting adjustments, and color correction based on the extracted feature maps. These corrections are applied using advanced algorithms that ensure minimal impact on image quality. Further, the electronic device (301) reconstructs the naturalness restored image based on the feature maps and the targeted corrections in the input image. The naturalness restored image resembles the input image of the scene with enhanced naturalness and visual fidelity. This process ensures that the final image is both aesthetically pleasing and true to the original scene.

Further, the naturalness restored image is reconstructed with the enhanced naturalness and the visual fidelity by leveraging the information included in the feature maps. These feature maps are processed using advanced algorithms that ensure accurate reconstruction of the original scene.

The electronic device (301) inputs the input image into the texture enhancement model to obtain the texture enhanced image. The enhanced texture characteristics of the scene include extracted, using the texture enhancement model (404), feature maps from the input image. These feature maps are rich in detail, capturing subtle variations in texture that are used for texture enhancement. The extracted feature maps include the enhanced texture characteristics regarding texture attributes. The texture characteristics include frequency of texture elements, the level of coarseness of fine details, homogeneity of patterns, and the level of surface roughness. The texture enhancement model enhances texture details in the input images by accentuating fine details, contours, and texture patterns, and the feature maps to improve the visual and structural quality of texture of the input image. These enhancements are applied using advanced algorithms that ensure minimal impact on image quality. The texture enhancement model generates the texture enhanced image involving the enhanced texture details. This process ensures that the final image is both aesthetically pleasing and true to the original scene. Further, the texture enhancement model enhances the texture details by accentuating striations and other texture patterns within the input image. These enhancements are applied using advanced algorithms that ensure minimal impact on image quality.

In an embodiment, training the texture enhancement model may be performed by the electronic device (301) (e.g., by the lightweight image restoration controller (305) or by the processor (301)) or another external electronic device (e.g., a server device). Training the texture enhancement model involves inputting the pair of images into a lightweight neural network architecture. The pair of images includes training images and the texture-enhanced image generated using proprietary filters. These filters are designed to highlight and improve specific textural attributes in the training image. The lightweight neural network includes a plurality of convolutional layers with varying spatial dimensions and depths to process the training image. These layers are configured to capture both global and local texture features, ensuring comprehensive enhancement. The neural network may be trained by using the pair of images, the set of filters, and the texture enhancement model dataset. The set of filters are configured to maintain the style and the pixel-level accuracy in the output image. The neural network iteratively learns through multiple learning iterations. The texture enhancement model enhances textures in the pair of images such that the enhanced textures exhibit an improved level of pattern regularity, a level of fine detail coarseness, and a level of surface roughness.

In an embodiment, creating the texture enhancement model dataset may be performed by the electronic device (301) (e.g., by the lightweight image restoration controller (305) or by the processor (301)) or another external electronic device (e.g., a server device). Creating the texture enhancement model dataset involves obtaining training images. The training images are captured by a specific camera sensor for which the texture enhancement model is to be deployed. This ensures that the model is finely tuned to the sensor's capabilities and limitations. The set of filters may be applied to the training images. The set of filters may comprise one or more proprietary filters. The set of filters are configured to improve the regularity and directionality of patterns in the images, increase the frequency and coarseness of existing fine details of the training images, and enhance a level of surface roughness of the training images. These filters are designed to mimic the effects of various environmental conditions, such as wind or water, on texture. The enhanced texture images may be generated from the training images based on the output from the set of filters. The texture enhancement model outputs enhanced texture images for processing or display. These images serve as a benchmark for evaluating the performance of the texture enhancement model.

The lightweight image restoration controller (305) trains the naturalness restoration model. In an embodiment, training the naturalness restoration model may be performed by another component of the electronic device (301) (e.g., by the processor (301)) or by another external electronic device (e.g., a server device). The training includes inputting the pair of images into a lightweight neural network architecture. This architecture is optimized for rapid convergence and minimal overfitting, ensuring efficient training cycles. The pair of images includes training images and the naturalness enhanced image. The lightweight neural network architecture includes a plurality of convolutional layers with varying spatial dimensions and depths to process training images. These layers are adept at capturing subtle variations in color and light, which are crucial for naturalness restoration. The neural network may be trained by using the pair of images, the set of filters, and the naturalness restoration model dataset. The set of filters are configured to maintain the style consistency and the pixel-level accuracy in the output image. The neural network iteratively learns through multiple learning iterations. The naturalness restoration model enhances naturalness features in the pair of images. The naturalness features include the level of color fidelity, the level of lighting accuracy, and the level of controlled noise patterns. This results in images that are not only visually pleasing but also true to the original scene.

In an embodiment, creating the naturalness restoration model dataset may be performed by the electronic device (301) (e.g., by the lightweight image restoration controller (305) or by the processor (301)) or another external electronic device (e.g., a server device). Creating the naturalness restoration model dataset involves capturing training images. The training images are captured using a specific camera sensor intended for deployment of the naturalness restoration model, thereby ensuring sensor specificity. This approach allows the model to account for unique sensor characteristics such as color response and noise profile. Proprietary filters may be applied to the captured training images. These filters are designed to simulate various environmental conditions, such as different lighting scenarios and atmospheric effects, to enhance the robustness of the model. The proprietary filters are configured to perform selective denoising on the training images to reduce noise while preserving image detail. Further, the proprietary filters enhance natural grain in the images to retain characteristics specific to the imaging sensor of the electronic device and improve overall detail and clarity of the images. The dataset may be generated based on an output from the proprietary filters. The dataset includes the processed images with enhanced naturalness elements suitable for use in training or deploying the naturalness restoration model specific to the imaging sensor of the electronic device. This dataset serves as a comprehensive training resource, enabling the model to deliver consistent performance across a wide range of scenarios.

In an embodiment, training the image restoration model may be performed by the electronic device (301) (e.g., by the lightweight image restoration controller (305) or by the processor (301)) or another external electronic device (e.g., a server device). The training includes generating degraded versions of training images by passing the training images through the synthetic degradation pipeline. This pipeline is designed to simulate a wide range of real-world conditions, such as low light or motion blur, to enhance the model's adaptability. The synthetic degradation pipeline is created by randomly varying degradation parameters to simulate real-world degradation scenarios. The degradation parameters include denoising operations, deblurring operations, super-resolution operations, and enhancement tasks operations. These operations are carefully calibrated to ensure that the degraded images closely resemble those captured in challenging conditions. The degraded versions of the training images may be mapped with corresponding enhanced counterparts to form the training dataset for the image restoration model. This mapping process is crucial for training the model to recognize and correct various types of image degradation. The feature maps obtained from the attention-based convolutional neural network (CNN) may be fused with output features or images obtained from the naturalness restoration model and the texture enhancement model. This fusion process leverages the strengths of each model, resulting in a comprehensive restoration solution.

Further, the CNN is trained based on the sensor-agnostic dataset. The sensor-agnostic dataset includes images captured from a wide range of devices under various lighting conditions and with different color profiles and resolutions. This ensures that the model is robust and adaptable to different imaging scenarios.

Further, the degraded versions of training images are created by applying a combination of the denoising operations, the deblurring operations, the super-resolution operations, and the enhancement tasks operations. These operations are carefully calibrated to ensure that the degraded images closely resemble those captured in challenging conditions.

The lightweight image restoration controller (305) generates the output image (e.g., the output image (406) of FIG. 4). The output image is obtained by fusing the intermediate enhanced image, the naturalness restored image, and the texture enhanced image by applying scenario-based weighting. This weighting is dynamically adjusted based on the specific characteristics of the input image, ensuring optimal enhancement. The scenario-based weighting is determined by factors including the defined zoom level of the input image, lighting conditions of the input image, and features of the input image. This approach ensures that the final output image is tailored to the specific conditions under which the input image was captured, resulting in a visually appealing and accurate representation of the original scene.

FIG. 4 illustrates the lightweight texture image restoration controller using pre-trained texture & naturalness according to the embodiment disclosed herein. This lightweight texture image restoration controller (305) comprises several components including a frame buffer (401), a naturalness restoration model (402), a lightweight image restoration engine (403), a texture enhancement model (404), and a fusion unit (405).

The frame buffer (401) is designed to handle high-speed data transfer from the camera sensor, ensuring that the input images are delivered to the subsequent processing units with minimal latency. It is equipped with a high-capacity memory module to store multiple frames simultaneously, including one or more input images, allowing for batch processing and temporal analysis of image sequences. The naturalness restoration model (402) and the texture enhancement model (404) are optimized for real-time processing, utilizing efficient algorithms that minimize computational overhead while maintaining high-quality output. The lightweight image restoration engine (403) acts as the central processing unit, coordinating the flow of data between the models and ensuring that the final output is a seamless blend of naturalness and texture enhancement. For example, the lightweight image restoration engine (403) may include the image restoration model.

In the configuration shown in FIG. 4, the frame buffer (401) supplies a set of frames from a camera sensor as an input image to the naturalness restoration model (402), the lightweight image restoration engine (403), and the texture enhancement model (404). These models (including the model included in the lightweight image restoration engine (403)) process the input image to enhance its quality. Both the naturalness restoration model (402) and the texture enhancement model (404) are designed as lightweight models. The naturalness restoration model (402) generates feature-rich priors that the lightweight image restoration engine (403) uses to produce natural-looking textures in images.

The frame buffer (401) is capable of handling various image formats and resolutions, adapting to different camera sensor outputs. The naturalness restoration model (402) employs a convolutional neural network (CNN) architecture that is specifically tailored to recognize and enhance natural features such as skin tones, foliage, and sky textures. The lightweight image restoration engine (403) integrates these enhancements with advanced image processing techniques like edge-preserving smoothing and adaptive histogram equalization to further refine the image quality. The texture enhancement model (404) utilizes a multi-scale approach to capture both macro and micro texture details, ensuring that the final image retains a high level of detail across different spatial frequencies.

The feature-rich priors embedded in these models provide a foundational understanding of natural textures and features, which the models leverage to improve image quality. Consequently, the resulting images appear more natural and detailed even if the original images were of lower quality.

These feature-rich priors are derived from extensive training on diverse datasets that include a wide range of natural scenes and textures. The models are capable of distinguishing between different types of noise and artifacts, selectively enhancing or suppressing them based on the context of the image. This capability is further enhanced by the use of attention mechanisms within the models, which allow them to focus on the relevant parts of the image during processing. As a result, the restored images exhibit improved dynamic range, color accuracy, and texture fidelity, making them suitable for applications in photography, surveillance, and medical imaging.

According to the present disclosure, the naturalness restoration model (402) is trained using a camera sensor-specific dataset and incorporates feature-rich priors to restore images to a more natural appearance. For instance, if an image is blurry or noisy, the model applies its prior knowledge about naturalness-such as color fidelity, lighting and shadow accuracy, detail and clarity, selective noise retention and removal, and patterns observed in nature-to enhance the image, making it more realistic and visually appealing.

The training process for the naturalness restoration model (402) involves the use of transfer learning techniques, where a pre-trained model is fine-tuned on a sensor-specific dataset to capture unique characteristics of the sensor output. This approach allows the model to adapt to variations in sensor noise patterns, color profiles, and dynamic range. The model's architecture includes residual connections and skip layers that facilitate the preservation of fine details while reducing computational complexity. Additionally, the model employs a perceptual loss function that aligns the restored image with human visual perception, ensuring that the enhancements are both technically accurate and aesthetically pleasing.

The naturalness restoration model (402) processes the input image by extracting fine features responsible for naturalness. The naturalness restoration model (402) includes two subnets: a naturalness feature extractor (402a) and a naturalness decoder (402b). The deep naturalness feature extractor (402a) extracts feature maps from the input images, capturing details like sensor noise characteristics, lighting and shadow accuracy, and color fidelity. These extracted features serve as conditioning inputs for the lightweight image restoration engine (403). The output from the naturalness feature extractor (402a) is then fed into the naturalness decoder (402b), which reconstructs the image with enhanced naturalness.

The naturalness feature extractor (402a) utilizes a series of convolutional layers with varying kernel sizes to capture both global and local features of the input image. The naturalness feature extractor (402a) employs batch normalization and dropout techniques to improve generalization and prevent overfitting during training. The extracted feature maps are multi-dimensional, representing different aspects of the image such as texture, color, and luminance. The naturalness decoder (402b) uses these feature maps to guide the reconstruction process, applying techniques like guided filtering and bilateral filtering to enhance the natural appearance of the image. The decoder also incorporates a feedback loop that iteratively refines the output, ensuring that the final image meets the quality standards.

The naturalness decoder (402b) focuses on feature details in specific regions to make the image appear more realistic and restore the natural appearance of processed images. The naturalness feature extractor (402a) provides the naturally restored image as output.

The naturalness decoder (402b) employs a region-based approach, where it identifies key areas of the image that require enhancement, such as faces, landscapes, or architectural elements. The naturalness decoder (402b) uses a combination of spatial attention mechanisms and region-specific filters to selectively enhance these areas, ensuring that the improvements are contextually appropriate. The naturalness decoder (402b) also integrates a color correction module that adjusts the hue, saturation, and brightness of the image to match the natural color palette. The output of the decoder is a high-resolution image that retains the original scene's naturalness while exhibiting improved clarity and detail.

Similarly, the texture enhancement model (404) is trained using camera sensor-specific data and incorporates feature-rich priors to enhance image textures. The texture enhancement model (404) applies prior knowledge about detailed textures-such as frequency and coarseness, regularity and directionality, homogeneity, edge density, and surface roughness—to improve image quality, adding depth and detail that make the textures appear more realistic.

The texture enhancement model (404) is designed to operate in both spatial and frequency domains, allowing it to capture a wide range of texture characteristics. The texture enhancement model (404) uses a wavelet transform to decompose the image into different frequency bands, enabling the model to focus on specific texture elements at various scales. The model's architecture includes dilated convolutions that expand the receptive field, allowing it to capture long-range dependencies and complex texture patterns. The training process involves the use of adversarial learning, where the model is trained alongside a discriminator network that evaluates the realism of the generated textures, ensuring that the enhancements are indistinguishable from natural textures.

The texture enhancement model (404) processes the input image by extracting fine features responsible for texture. The texture enhancement model (404) includes two subnets: a texture feature extractor (404a) and a texture decoder (404b). The deep texture feature extractor (404a) extracts feature maps from input images including information regarding the frequency of texture elements, coarseness of fine details, and homogeneity of patterns. These features are used as conditioning inputs for the lightweight image restoration engine (403). The output of the texture feature extractor (404a) is subsequently fed into the texture decoder (404b), which reconstructs the image with enhanced texture. In an embodiment, the feature maps (1203) may correspond to (or represent) one or more enhanced texture characteristics of a scene corresponding to the input frame (1201).

The texture feature extractor (404a) employs a hierarchical structure, where each layer is responsible for capturing different levels of texture detail, from coarse to fine. The texture feature extractor (404a) uses a combination of convolutional and pooling layers to progressively refine the feature maps, ensuring that the extracted features are both comprehensive and discriminative. The texture decoder (404b) utilizes these feature maps to guide the texture reconstruction process, applying techniques like texture synthesis and inpainting to fill in missing details and enhance existing textures. The decoder also incorporates a texture blending module that seamlessly integrates the enhanced textures with the original image, ensuring that the final output is both realistic and visually coherent.

The texture decoder (404b) utilizes the input feature maps to enhance texture details in the images, improving fine details and contours, and provides the texture-enhanced image as output.

The texture decoder (404b) employs a contour enhancement algorithm that enhances fine details and contours, making the textures more pronounced and visually appealing. The texture decoder (404b) applies morphological operations to identify and enhance contours, ensuring that the textures are well-defined and across the image. The decoder also includes a texture refinement module that iteratively improves the texture quality, applying techniques like anisotropic diffusion and non-local means filtering to reduce noise and enhance detail. The final output is a texture-enhanced image that exhibits improved depth, contrast, and realism, making it suitable for applications in digital art, gaming, and virtual reality.

The lightweight image restoration engine (403) receives the extracted feature map with naturalness information from the naturalness feature extractor (402a) along with features extracted with deep texture information from the texture feature extractor (404a) and the input image. The lightweight image restoration engine (403) provides the restored image with deblurring, denoising, detail enhancement, and super-resolution. This combination is used to obtain an intermediate enhanced image corresponding to the input image.

The lightweight image restoration engine (403) integrates a multi-task learning framework that simultaneously addresses various image restoration tasks, such as deblurring, denoising, and super-resolution. The lightweight image restoration engine (403) employs a shared encoder-decoder architecture that processes the input feature maps in parallel, ensuring that the restoration tasks are performed efficiently and effectively. The engine uses various techniques to enhance image quality, including denoising methods to remove artifacts and improve clarity. The intermediate enhanced image serves as a high-quality baseline that is further refined by the fusion unit (405) to produce the final output.

In an embodiment, the lightweight image restoration engine (403) may input the input image along with the extracted feature maps from the naturalness feature extractor (402a) and the texture feature extractor (404a) to the image restoration model. The lightweight image restoration engine (403) may obtain the restored image (or the intermediate enhanced image) from the image restoration model.

Further, the fusion unit (405) combines the outputs of the naturalness restoration model (402), the texture enhancement model (404), and the intermediate enhanced image from the lightweight image restoration engine (403) using specific weights and scene types to produce a natural and texture-rich restoration in the output image (406).

The fusion unit (405) employs a weighted averaging approach, where the contributions of the naturalness restoration model (402), texture enhancement model (404), and the intermediate enhanced image are combined based on their relevance to the scene type. The fusion unit (405) uses a scene classification module that identifies the dominant features of the input image, such as landscape, portrait, or urban, and adjusts the fusion weights accordingly. The fusion unit (405) also incorporates a blending algorithm that ensures smooth transitions between different regions of the image, preventing artifacts and ensuring a cohesive final output. The result is a natural and texture-rich image that exhibits enhanced detail, color accuracy, and visual appeal, making it suitable for a wide range of applications.

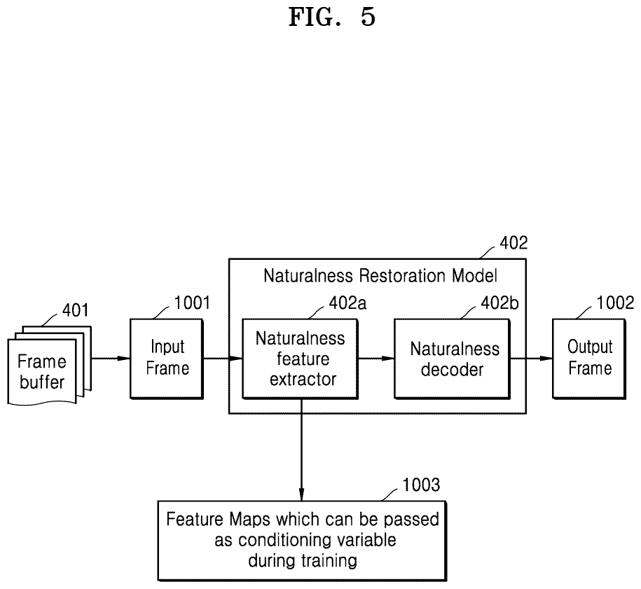

FIG. 5 illustrates working operation naturalness restoration model according to the embodiment disclosed herein. The frame buffer (401) supplies a set of frames from a camera sensor serving as an input image to the naturalness restoration model (402). For example, the frame buffer (401) may provide an input frame (1001) to the naturalness restoration model (402). This input frame (1001) undergoes processing by the naturalness restoration model (402), which is a lightweight model specifically trained with camera sensor-specific data. The input frame (1001) may be referred to as an input image. The naturalness restoration model (402) aims to preserve natural color tones, fine details, and textures while adding grainy sensor noise. Training of the naturalness restoration model (402) involves a sensor-specific dataset to compute sensor-specific characteristics in the feature map and a set of filters to create a naturalness restoration dataset. These filters are configured to maintain style and pixel-level accuracy in an output frame (1002). The output frame (1002) may be referred to as an output image from the naturalness restoration model (402).

The naturalness restoration model (402) is designed to operate efficiently on edge devices, utilizing quantization and pruning techniques to reduce model size and computational requirements. The naturalness restoration model (402) employs a set of adaptive filters that dynamically adjust their parameters based on the input image characteristics, ensuring that the restoration process is both accurate and efficient. The training process of the naturalness restoration model (402) involves the use of data augmentation techniques, such as random cropping and rotation, to increase the diversity of the training dataset and improve the model's generalization capabilities. The resulting model (e.g., the naturalness restoration model (402)) is capable of producing high-quality images with minimal computational overhead, making it suitable for deployment in resource-constrained environments.

The training dataset is further developed using proprietary filters that introduce naturalness elements into the images. These filters apply selective denoising to reduce noise without losing detail, enhance natural grain to retain sensor-specific characteristics, and improve overall detail and clarity. Input images are captured from the specific camera sensor where the models will be deployed, ensuring that the dataset remains sensor-specific. In an embodiment, the training dataset for the naturalness restoration model (402) may be referred to as the naturalness restoration model dataset.

The proprietary filters used in the dataset development process are designed to mimic the characteristics of high-quality camera sensors, ensuring that the restored images exhibit a natural and realistic appearance. These filters employ a combination of spatial and frequency domain techniques to selectively enhance image quality, applying methods not only limited to bilateral filtering and non-local means denoising, but also includes advanced denoising models and tools like photoshop, lightroom, to reduce noise while preserving detail. The filters also incorporate a grain enhancement module that adds realistic sensor noise patterns to the images, ensuring that the restored images retain the unique characteristics of the original sensor output. The resulting dataset (e.g., the training dataset for the naturalness restoration model (402)) is highly representative of the target sensor, ensuring that the model is well-suited for deployment in real-world applications.

The naturalness restoration model (402) comprises two subnets: the naturalness feature extraction (402a) and the naturalness decoder (402b). The naturalness feature extraction (402a) extracts feature maps from the input images, capturing information such as sensor noise characteristics, lighting and shadow accuracy, and color fidelity. Additionally, the naturalness feature extraction (402a) applies targeted corrections to the input image, including noise reduction, lighting adjustments, and color correction based on the extracted feature maps. Consequently, the naturalness feature extraction (402a) reconstructs the naturalness-restored image based on the feature maps and targeted corrections in the input image. From the naturalness feature extraction (402a), one or more feature maps (1003) may be obtained. In an embodiment, the feature maps (1003) can be passed as conditioning variable during the training of the naturalness restoration model (402).

The naturalness feature extraction (402a) employs a deep convolutional neural network (CNN) architecture that is specifically designed to capture the unique characteristics of the input image. The naturalness feature extraction (402a) uses a combination of convolutional and pooling layers to extract multi-scale feature maps (1003), ensuring that the extracted features are both comprehensive and discriminative. The feature extraction process is guided by a set of learned filters that are optimized to capture the relevant aspects of the input image, such as texture, color, and luminance. The resulting feature maps (1003) are used to guide the reconstruction process, ensuring that the restored image exhibits a high level of naturalness and visual appeal.

The extracted feature maps (1003) serve two primary purposes. Firstly, the feature maps (1003) provide conditioning input for any lightweight image restoration engine (403), ensuring that the restoration process is informed by the detailed characteristics of the input image. Secondly, the output of the naturalness feature extraction (402a) is fed into the naturalness decoder (402b), which utilizes these features to enhance the naturalness of the final image output. In an embodiment, the feature maps (1003) may correspond to (or represent) one or more restored natural characteristics of a scene corresponding to the input frame (1001).

The extracted feature maps (1003) are multi-dimensional representations of the input image, capturing a wide range of characteristics such as texture, color, and luminance. The feature maps (1003) are used to guide the restoration process, ensuring that the final output is both accurate and visually appealing. The naturalness decoder (402b) employs a set of learned filters that are optimized to enhance the naturalness of the input image, not only applying techniques like guided filtering and bilateral filtering, but also applying other methods or techniques to improve image quality. The resulting image (e.g., the output frame (1002)) exhibits a high level of naturalness and visual appeal, making it suitable for a wide range of applications.

For instance, in a low-light photograph with significant noise and poor color accuracy, the naturalness feature extraction (402a) identifies and detects noise, lighting inaccuracies, and color discrepancies. These identified features assist the restoration process, resulting in an output image with reduced noise, accurate lighting and shadows, and true-to-life colors, making the image appear more natural and visually appealing.

The naturalness feature extraction (402a) employs a set of learned filters that are specifically designed to capture the unique characteristics of low-light images, such as noise, lighting inaccuracies, and color discrepancies. These filters are optimized to capture the most relevant aspects of the input image, ensuring that the restoration process is both accurate and efficient. The resulting feature maps (1003) are used to guide the restoration process, ensuring that the final output is both accurate and visually appealing. The resulting image exhibits a high level of naturalness and visual appeal, making it suitable for a wide range of applications.

The naturalness decoder (402b) restores and enhances the natural appearance of processed images by focusing on boosting extracted feature details in specific regions to make the image look more realistic. The naturalness decoder (402b) utilizes the input feature maps to perform selective denoising, introduces appropriate sensor noise patterns, enhances color fidelity, and ensures accurate lighting and shadow details. For example, the naturalness decoder (402b) evaluates the image, reduces noise selectively, and introduces sensor noise patterns that mimic those of a high-quality camera. Additionally, the naturalness decoder (402b) adjusts colors to make them more effective and enhances lighting and shadows to make the image look more natural and visually appealing.

The naturalness decoder (402b) employs a set of learned filters that are specifically designed to enhance the naturalness of the input image, not only applying techniques like guided filtering and bilateral filtering, but also applying or using other methods or techniques to improve image quality. The naturalness decoder (402b) also incorporates a feedback loop that iteratively refines the output, ensuring that the final image meets the quality standards. The resulting image (e.g., the output frame (1002)) exhibits a high level of appeal, making it suitable for a wide range of applications.

The naturalness restoration model (402) ensures that images undergo selective denoising, targeting specific areas that require noise reduction while preserving necessary sensor noise patterns. This selective approach helps maintain the authenticity of the image. Furthermore, the restoration process aims to reconstruct the image with enhanced naturalness, utilizing the information contained in the feature maps. Accurate lighting and shadow details are integrated into the images to enhance their natural appearance. Moreover, naturalness is restored by selective denoising to reduce noise without losing detail, enhance natural grain to retain sensor-specific characteristics, and improve overall detail and clarity.

The naturalness restoration model (402) employs a set of learned filters that are specifically designed to capture the unique characteristics of the input image, ensuring that the restoration process is both accurate and efficient. An architecture of the naturalness restoration model (402) includes residual connections and skip layers that facilitate the preservation of fine details while reducing computational complexity. Additionally, the naturalness restoration model (402) employs a perceptual loss function that aligns the restored image with human visual perception, ensuring that the enhancements are accurate and aesthetically pleasing. The resulting image exhibits a high level of naturalness and visual appeal, making it suitable for a wide range of applications.

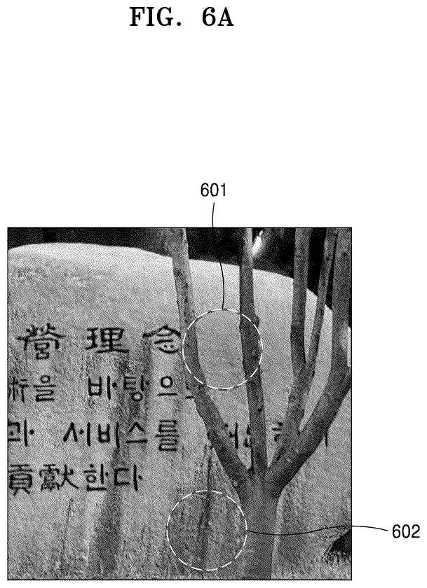

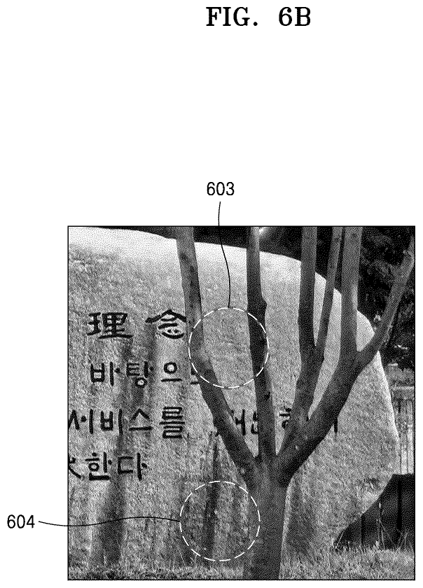

FIG. 6A and FIG. 6B illustrate examples for understanding image restoration properties in terms of naturalness according to the disclosed embodiment. FIG. 6A depicts an image of a rock with branches captured by an existing system, while FIG. 6B shows an image of the same scene obtained using the proposed disclosure.

In FIG. 6B, the highlighted portion demonstrates improved color saturation of the rock and visible grainy patterns, whereas these details are lost in FIG. 6A (601, 602). This comparison underscores the significance of clarity, lighting, and shadow details in achieving naturalness.

Further analysis of FIG. 6A reveals a lack of detail and clarity. The rock's color saturation is poor (601), and the grainy patterns (602) are not visible. Additionally, inadequate lighting and shadow details result in an unnatural appearance.

Conversely, FIG. 6B, captured using the proposed natural restoration model, exhibits enhanced color saturation (604) and visible grainy patterns (603) on the rock. Accurate representation of lighting and shadow details enhances the image's naturalness. The overall clarity and detail are preserved, making the image appear more realistic and visually appealing.

Furthermore, image naturalness pertains to the degree to which an image replicates the visual characteristics perceived by a camera sensor under normal viewing conditions without distortion or high-scale zoom. Elements such as color fidelity, lighting and shadow accuracy, detail and clarity, and selective noise retention and removal are used in assessing image naturalness.

Color fidelity denotes the accuracy with which colors in the image represent their real-world counterparts. An image with high color fidelity will exhibit hues, saturation, and brightness that closely mimic those observed in natural settings, free from artificial tints or distortions.

Lighting and shadow accuracy is a type of naturalness further influenced by the depiction of lighting and shadows.

Detail and clarity evaluate the sharpness and definition of elements within the image. High naturalness is characterized by images that preserve fine details and clear boundaries without succumbing to excessive blurring or over-sharpening, which can introduce unnatural visual cues.

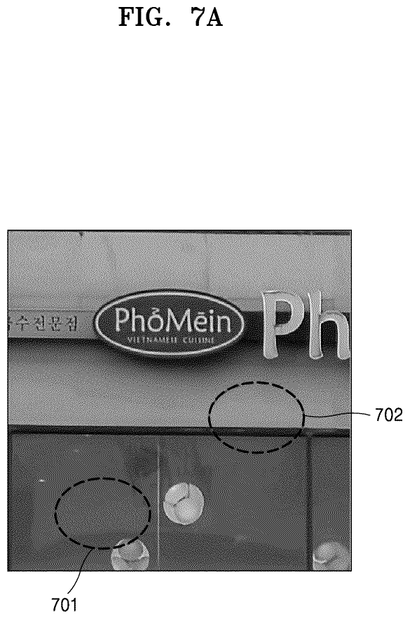

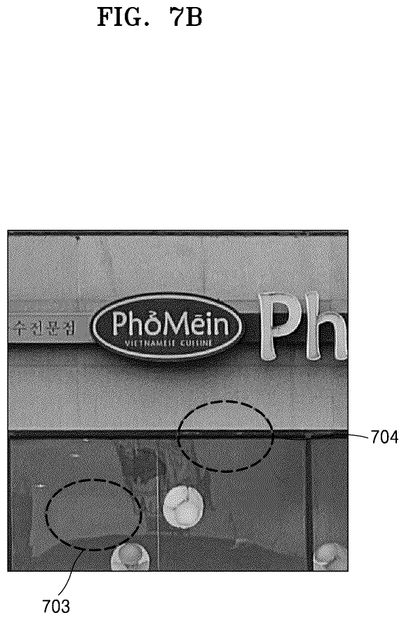

The embodiment disclosed in the figures presents a novel approach to image restoration that emphasizes the importance of selective noise retention and removal to enhance the naturalness of digital images. In FIG. 7A, the image captured by an existing system appears overly synthetic (701) due to the absence of grainy sensor noise (702), which is a common artifact in real-world photography. This lack of noise, while often perceived as a mark of high-quality digital processing, can inadvertently strip away the authenticity that grainy textures contribute to an image. By contrast, FIG. 7B showcases the same scene processed through the present disclosure, which intelligently retains a controlled amount of noise. This selective noise retention is used in maintaining the image's natural appeal, as it mimics the subtle imperfections found in traditional film photography, thereby enhancing the viewer's perception of realism.

The technique employed by the present disclosure involves a delicate balance between noise retention and removal. By preserving a slight level of grainy noise, the present disclosure ensures that images do not appear overly polished or artificial, which can detract from their authenticity. The challenge lies in avoiding excessive noise that can obscure details and reduce image quality. The embodiments of the present disclosure have the ability to manage noise levels carefully results in images that are both realistic and high-quality. This balance is achieved through sophisticated algorithms that assess the noise characteristics of an image and apply targeted denoising processes only where necessary, ensuring that the final output maintains clarity and detail without losing its natural essence.

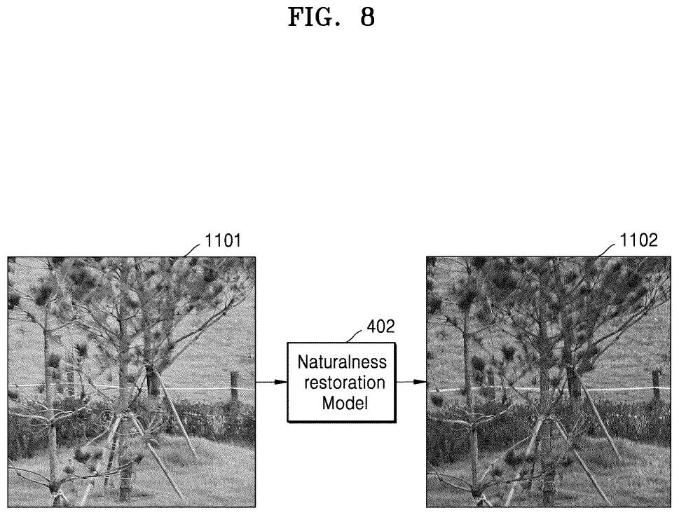

FIG. 8 further elaborates on the technical process behind the image restoration technique according to embodiments herein. The input image (1101) undergoes a selective denoising process within the naturalness restoration model (402), which identifies specific areas that require noise reduction while preserving sensor noise patterns. This selective approach is used in maintaining the authenticity of the image, as it allows for the retention of natural textures and details that contribute to the overall realism. The restoration process also focuses on enhancing color fidelity, ensuring that colors appear true to life (see an output image (1102)). Accurate lighting and shadow details are meticulously integrated into the images, further enhancing their natural appearance. The comprehensive approach, which includes naturalness feature extraction (402a) and a sophisticated decoding process, ensures that the final output is a high-quality, natural-looking image. This results in visually appealing and realistic images that resonate with viewers, offering an enhanced visual experience that bridges the gap between digital precision and natural authenticity.

FIG. 9 is a block diagram that provides a comprehensive illustration of the operational workflow of the texture enhancement model, as disclosed in the embodiment herein. The frame buffer (401), which serves as the initial point of contact for an input frame (1201), may be derived from a camera sensor. This input frame (1201), also referred to as an input image, is subsequently processed by the texture enhancement model (404). The texture enhancement model (404) is meticulously trained using data specific to the camera sensor, ensuring that the enhancements applied are finely tuned to the characteristics of the images captured by that particular sensor. The texture enhancement model (404) may generate an output frame (1202). The output frame (1202) may be referred to as an output image or a texture enhanced image from the texture enhancement model (404).

The dataset (e.g., the texture enhancement dataset) utilized for training the texture enhancement model (404) is crafted using specialized filters designed to augment the regularity and directionality of patterns within the image. These filters amplify the frequency and coarseness of fine details, thereby improving the surface roughness and resulting in a significantly enhanced texture. By focusing on these aspects, the texture enhancement model (404) is able to deliver images that are not only more detailed but also visually appealing, which is particularly beneficial in applications requiring high-quality visual outputs.

The architecture of the texture enhancement model (404) is notably lightweight, which is advantageous for deployment on devices with limited computational resources. The texture enhancement model (404) comprises two primary subnets: the texture feature extraction (404a) and the texture decoder (404b). The texture feature extractor (404a) is tasked with extracting feature maps (1203) from the input images. These feature maps (1203) encapsulate information regarding the frequency of texture elements, the coarseness of fine details, the homogeneity of patterns, and the surface roughness. This extracted data (e.g., a feature map from the feature maps (1203)) forms the foundation upon which the subsequent texture enhancement processes are built. In an embodiment, the feature maps (1203) can be passed as conditioning variable during training of the texture enhancement model (404).

In addition to its primary function, the texture enhancement model (404) also integrates with a lightweight image restoration engine (403). The features (e.g., feature maps (1203)) extracted by the deep texture feature extractor (404a) are utilized as conditioning inputs for this restoration engine. This integration ensures that the restored image retains its natural texture while benefiting from enhanced details. The naturalness decoder (402b) reconstructs the image with these enhanced texture details. The naturalness decoder (402b) accentuates fine details, contours, and texture patterns, such as striations, within the input images, producing the texture enhanced image (1202) that is rich in texture and detail.

The texture decoder (404b) leverages the input feature maps to further refine the texture details in the images. By emphasizing fine details and contours, the texture decoder (404b) enhances the overall texture quality and naturalness of the image. This process involves accentuating various texture patterns, ensuring that the final output is visually enriched and maintains a natural appearance. An ability of the texture decoder (404b) to embed texture and details into the output frame (1202) of the texture enhanced image is a testament to effectiveness in delivering high-quality, texture-enhanced images of the texture enhancement model (404).

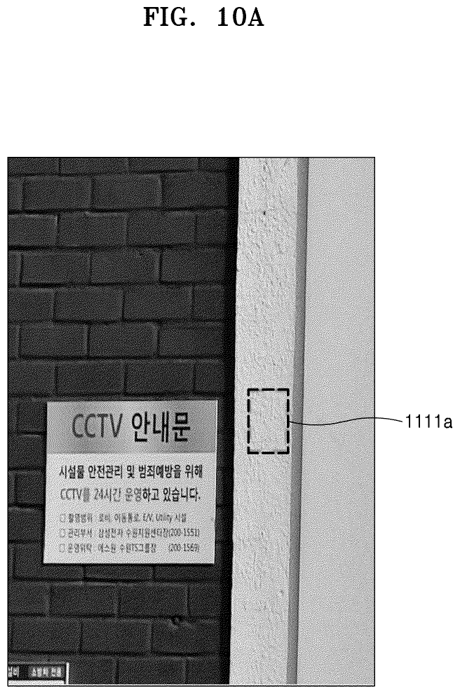

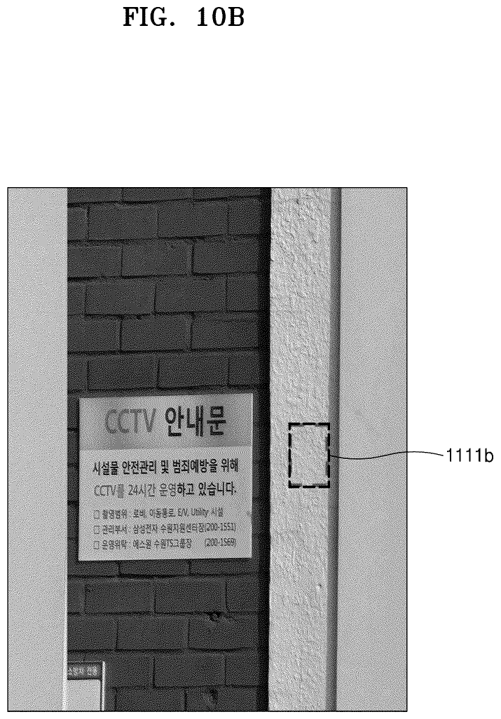

FIG. 10A and FIG. 10B illustrates the example understanding image restoration property in term of “Texture”, according to the embodiment disclosed herein. These figures serve as a comparative analysis between existing technology and the improved techniques proposed. In FIG. 10A, the texture on the wall is captured using existing technology, which results in an irregular texture with less coarseness (see a highlighted portion (1111a)). This irregularity often leads to a less natural appearance, as the fine and flat textures fail to replicate the authentic look of real-world surfaces. Conversely, FIG. 10B demonstrates the improved texture restoration capabilities of the new technology, where the highlighted portion (1111b) reveals a regularity in texture with enhanced coarseness. This regularity and coarseness contribute to a more natural and realistic appearance, which is used for applications requiring high fidelity in image restoration.

The texture is defined by its spatial frequency, which refers to the repetition of elements within an image. Some patterns may repeat randomly yet at regular intervals, contributing to the overall texture perceived by the observer. As highlighted in portions 1111a and 1111b, these patterns manifest as textures throughout the image, playing a significant role in the visual perception of the surface. The textures that are too fine and flat, as seen in FIG. 10A, may not appear natural. In contrast, some regions require a coarse and grainy texture to achieve a realistic look, as effectively demonstrated in FIG. 10B, where the texture and pattern are regular.

Textures are characterized by several distinct attributes that define their visual and structural properties, which are used for accurately describing, analyzing, and manipulating textures within images. These key attributes include frequency and coarseness, regularity and directionality, homogeneity, edge density, and surface roughness. Frequency and coarseness are fundamental types of texture attributes. Spatial frequency denotes the rate of change of texture elements, with high frequency indicating fine details and low frequency indicating broad features. Texture coarseness measures the granularity of elements, distinguishing coarse textures with large features from fine textures with small elements. Regularity assesses the uniformity and predictability of texture patterns, with highly regular textures displaying repeating elements. Directionality evaluates the predominant orientation of elements, distinguishing textures with aligned directions from isotropic textures with no preferred direction. Additionally, homogeneity evaluates the similarity of elements within a region, with high homogeneity indicating a uniform appearance and low homogeneity indicating diverse texture. Furthermore, edge density quantifies the number of edges or transitions within a specified area, with high edge density indicating frequent changes and low edge density indicating smoother texture. Surface roughness measures the unevenness of a texture's surface, distinguishing rough textures with significant variations in height and depth from smooth textures with minimal deviation. These attributes collectively contribute to the comprehensive understanding and manipulation of textures in image restoration processes.

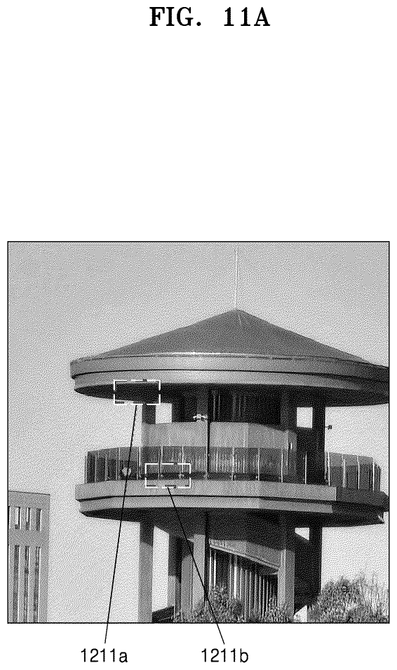

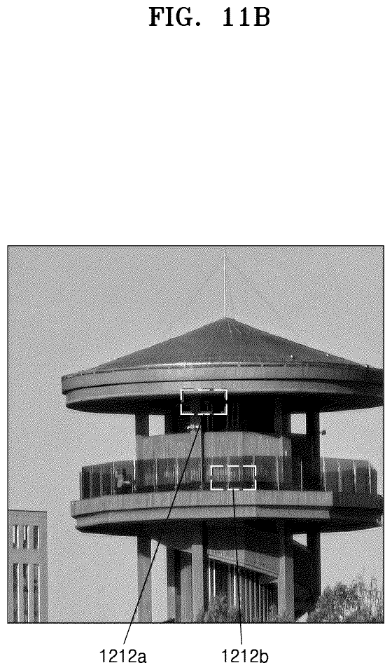

FIG. 11A and FIG. 11B is illustrating the example of understanding image restoration property in terms of Texture according to the embodiment disclosed herein. In FIG. 11A, the highlighted portions (1211a and 1211b) discloses a building with less edge density and more prominent detail loss (see the portion (1211a)) as well as minimal surface roughness and less granularity (see the portion (1211b)). The image in FIG. 11A was captured using a conventional imaging device, which lacks advanced texture processing capabilities. The device's limitations in capturing fine details result in a smoother, less defined texture, which is evident in the loss of intricate architectural features. The minimal surface roughness and granularity indicate that the image processing algorithm used does not adequately enhance the micro-textures that contribute to the perception of depth and realism. FIG. 11B is captured by the proposed device, where the highlighted portions (1211a and 1212b) discloses edges around the structure that are more prominent (see the portion (1212a)) and better surface roughness and granularity owing to better overall texture (see the portion (1212b)), resulting in an improved overall texture (see the portion (1212b)). The proposed device utilizes an advanced image processing algorithm that enhances edge detection and texture mapping, allowing for a more accurate representation of the building's architectural details. This improvement is achieved through a combination of edge-preserving filters and texture synthesis techniques that work together to maintain the integrity of the original image while enhancing its visual appeal.

In FIG. 11A, the edge density is low, indicating fewer edges or transitions within the specified area, which contributes to the loss of detail. This results in a smoother texture that lacks definition. The low edge density is a consequence of the imaging system's inability to differentiate between subtle changes in pixel intensity, leading to a homogenized appearance. However, in FIG. 11B, the edge density is higher, with more prominent edges around the structure. This increased edge density enhances the clarity and definition of the texture, making the structure appear more distinct and detailed. The higher edge density is achieved through the use of a sophisticated edge detection algorithm that identifies and enhances transitions between different textures and materials. This algorithm employs a multi-scale approach, analyzing the image at various resolutions to ensure that both macro and micro-textural details are preserved and enhanced.

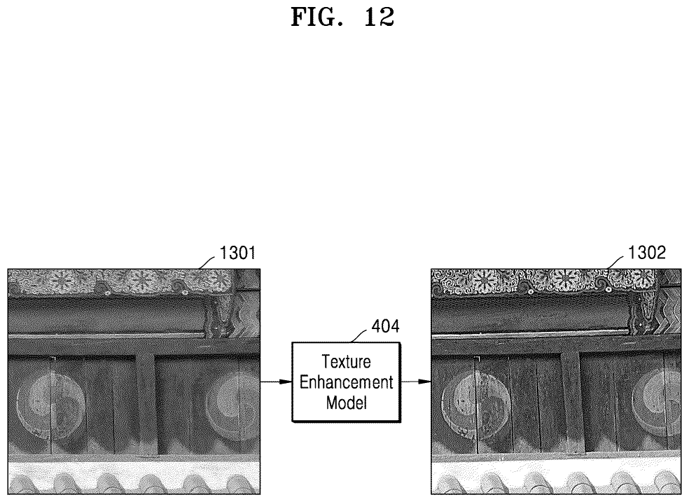

FIG. 12 is the block diagram that illustrates the output image (1302) of the texture enhancement model (404) using an input image according to the embodiment disclosed herein. The input image (1301) is passed to the texture enhancement model (404) and undergoes enhancement of fine details. This process accentuates contours and striations to improve the overall texture quality. The enhancement process aims to highlight and improve the visual and structural texture elements. The texture enhancement model (404) employs a neural network architecture specifically designed for texture analysis and enhancement. The texture enhancement model (404) utilizes convolutional layers to extract texture features and fully connected layers to refine and enhance these features. By leveraging detailed texture features (404a) and a decoding process (404b), the texture enhancement model (404) ensures high-quality texture enhancement, making images appear more detailed and visually appealing. The texture decoder (404b) reconstructs the enhanced image by integrating the refined texture features back into the original image framework, ensuring that the enhanced textures are seamlessly blended with the existing image content. This approach not only improves the visual quality of the image but also maintains the natural appearance of the textures, providing a more realistic and immersive viewing experience.

FIG. 13 is the block diagram that illustrates the working of the lightweight image restoration engine (403), according to the embodiment disclosed herein. The lightweight image restoration engine (403) receives an extracted feature map with naturalness information from the naturalness feature extractor (402a), alongside features extracted with deep texture information from the deep texture feature extractor (404a), and the input image (1401). These feature maps provide prior information about sensor noise characteristics, natural patterns, fine details, and contours. Furthermore, the lightweight image restoration engine (403) incorporates sensor-specific details about tone, texture, and noise patterns into the restoration process.

Responsibilities such as denoising, deblurring, super-resolution, and detail enhancement are assigned to the lightweight image restoration engine (403) during its training. Input frames (1401) from the frame buffer (401) are passed through a synthetic degradation pipeline to create degraded versions, which are then paired with their enhanced counterparts. The dataset employed is sensor-agnostic, meaning it is not specific to any particular camera sensor.

Upon processing these inputs, the lightweight image restoration engine (403) provides a restored image (1402) with deblurring, denoising, detail enhancement, and super-resolution. This process results in an intermediate enhanced image (also referred to as restored image with deblurring, denoising, detail enhancement (1402) in FIG. 13) that combines deep features with those from the lightweight image restoration engine (403), acting as the attention mechanism. This mechanism ensures selective noise retention, identifies textures and finer details, and differentiates them from sensor noise, enhancing textures and finer details to produce naturally looking, visually pleasing images.

For instance, when a user has a photo of a landscape with intricate details like leaves, grass, and shadows, the lightweight image restoration engine (403) utilizes the naturalness information extracted by the naturalness feature extractor (402a) and the deep texture information obtained from the deep texture feature extractor (404a), in combination with the original image (e.g., the input frames 1401). These inputs are processed to generate the enhanced version of the landscape photo. The enhanced image represents more defined textures of the leaves and grass while also presenting lighting and shadows in a more natural and visually appealing manner.

In an embodiment, the lightweight image restoration engine (403) may comprise the image restoration model, and use the image restoration model for the restoration process. The lightweight image restoration engine (403) may input the input frames (1401) together with the feature maps (or characteristics) from the natural restoration model (402) and the texture enhancement model (404). The image restoration model may output the restored image (1402) based on the feature maps (1003, 1203) from the natural restoration model (402) and the texture enhancement model (404).

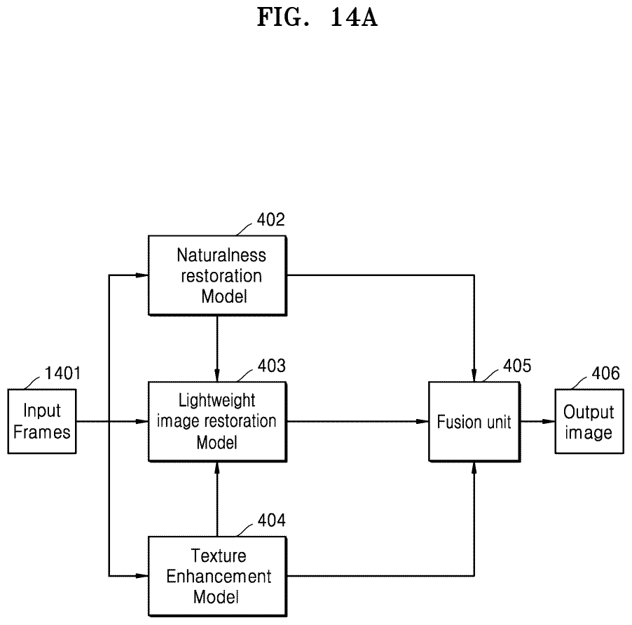

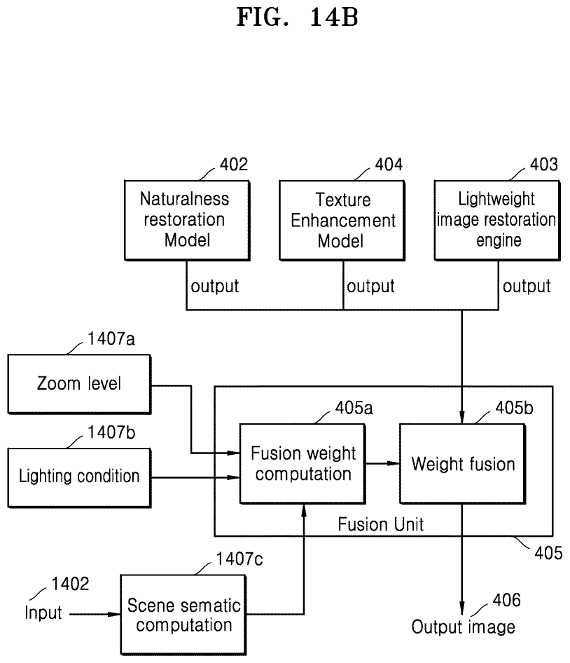

FIG. 14A and FIG. 14B are the block diagrams that illustrate the working of the fusion unit according to the embodiment disclosed herein. In FIG. 14A, the fusion unit (405) combines the outputs (e.g., the naturalness restored image or the output frame (1002) of FIG. 5) of the naturalness restoration model (402), outputs (e.g., the texture enhanced image or the output frame (1202) of FIG. 9) of the texture enhancement model (404), and output of the intermediate enhanced image (e.g., the restored image (1402) of FIG. 13) from the lightweight image restoration engine (403) using specific weights along with scene types to produce a natural and texture-rich restoration in the output image (406). The naturalness restoration model (402) outputs images with natural features, selective denoising, sensor-specific patterns, and improved color fidelity. The texture enhancement model (404) outputs images with enhanced finer details, contours, and striations based on the texture's periodicity and granularity. The combined naturalness and texture-aware image restoration model generates outputs based on tasks like super-resolution, denoising, detail enhancement, and deblurring. These outputs are fused together, by the fusion unit (405), using specific weights and scene types to produce restoration that is both natural and rich in texture. The method of combining and preference given to each input varies depending on the scene type and task at hand. This integration helps in effectively restoring images with accurate natural characteristics and textures.

FIG. 14B illustrates the scene-aware image fusion unit. The naturalness restoration model (402) contributes significantly by embedding natural features and enhancing color fidelity, used for low-light conditions. The texture enhancement model (404) adds finer details and contours, making the textures more pronounced and visually appealing. The lightweight image restoration engine (403) ensures the image is clear and free from noise, which is often prevalent in low-light captures. By merging outputs, from the naturalness restoration model (402), the texture enhancement model (404), and the lightweight image restoration engine (403), with the specified weights, the fusion unit (405) produces the output image (406) that is not only natural and detailed but also adapted to the specific capture scenario, thereby providing a visually pleasing and high-quality result. The fusion unit (405) may comprises a fusion weight computation unit (405a) and a weighted fusion unit (405b).

In an embodiment, the fusion weight computation unit (405a) may determine specific weights for the naturalness restoration model (402), the texture enhancement model (406), and the lightweight image restoration engine (403), respectively. Based on the model-specific weights, the weighted fusion unit (405b) may compute a weighted average of the received outputs. For example, in the fusion weight computation process, the fusion weight computation unit (405a) assigns weights to the texture enhancement model (404) in an order such as W3>W2>W1, emphasizing fine details at the potential cost of increased noise. Similarly, if the naturalness restoration model's (402) weights are arranged as W3>W2>W1, the tone becomes more natural, though this may result in reduced detail and potential oversaturation. The fusion weight computation unit (405a) may determine the model-specific weights based on scene analysis. Scene analysis considers factors like the zoom level (1407a), the lighting condition (1407b), and/or the scene semantic map of the input image (1402). For example, the fusion weight computation unit (405a) identifies whether the input image was captured at low (e.g., 10×) or high zoom, for example, whether an image was captured at a 100×zoom level. The fusion weight computation unit (405a) identifies the lighting conditions (1407b) that determine if the scene is in bright or low light. The fusion weight computation unit (405a) identifies the semantic map (generated by the scene semantic computation unit (1407c)) providing context about object types and arrangements. Based on the scene analysis, the fusion unit (405) dynamically adjusts weights to optimize the output image (406) quality.

For example, in wildlife photography of a bird taken at high zoom (100×) in low light, the texture enhancement model's (404) weights might be set to prioritize fine details of the bird's feathers, while the naturalness restoration model's (402) weights enhance the bird's natural tones but risk oversaturation. The fusion unit (405) evaluates these conditions, increasing the weight for the texture enhancement output while moderating the naturalness restoration weight, ensuring the final image captures intricate feather details and maintains a natural appearance without being overly bright. This dynamic weight assignment approach leads to high-quality images that effectively reflect the essence of the scene.

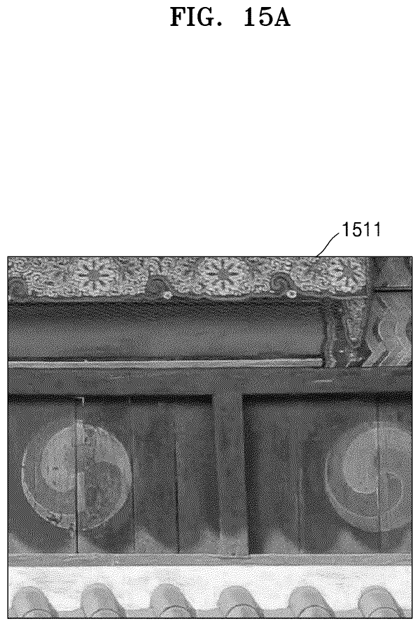

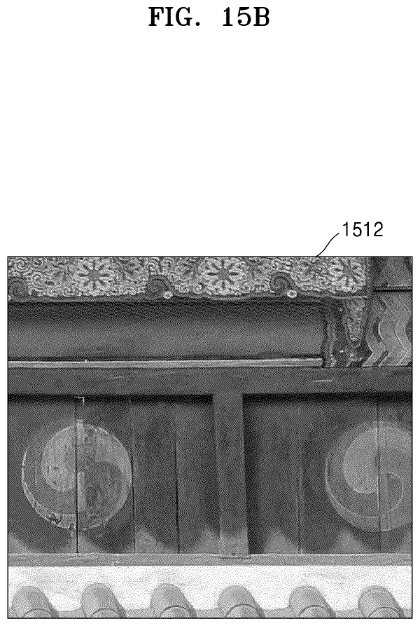

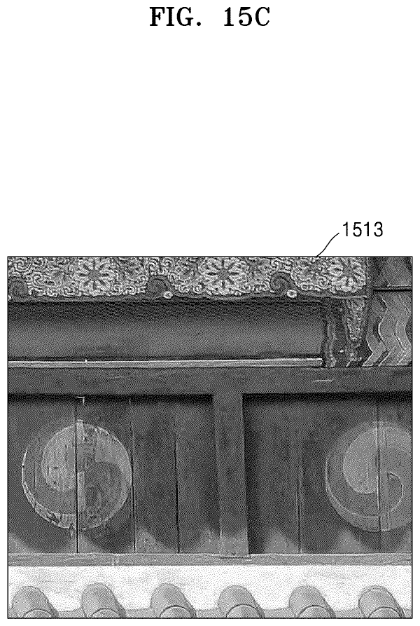

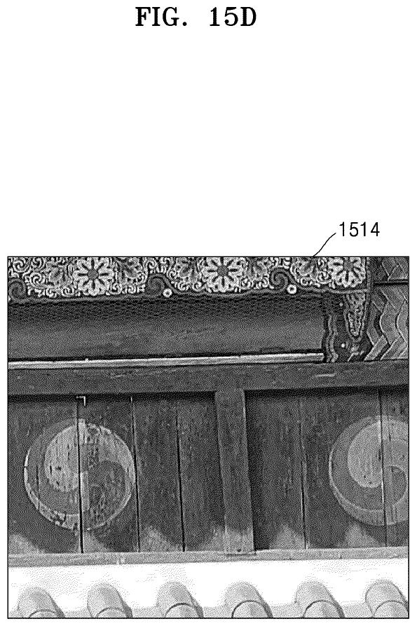

The FIG. 15A to FIG. 15D provides a comprehensive overview of how varying weight assignments can significantly alter the output of an image enhancement process. In FIG. 15A, an input image (1511) serves as the baseline, capturing the original details as perceived by the sensor. The input image (1511) includes a natural representation of textures, colors, and lighting conditions, which are used for understanding the subsequent changes introduced by the enhancement process. The original image is characterized by its unaltered state, providing a reference point for evaluating the impact of different enhancement weights.

Referring to FIG. 15B, applying weight W1 to the texture enhancement model (404) subtly refines the image. This mild enhancement improves texture while preserving the image's overall appearance and authenticity, offering a slight clarity boost (see an image (1512)). It is ideal for scenarios needing minimal enhancement, maintaining the image's natural look with a touch of refinement.

As the enhancement process reaches FIG. 15C, applying weight W2 significantly improves fine details and textures, sharpening intricate features. This is beneficial for applications needing enhanced detail visibility but introduces slight noise, resulting in a grainier appearance (see an image (1513)). This trade-off underscores the need to balance detail enhancement with noise management by selecting the appropriate weight. In FIG. 15D, applying weight W3 maximizes detail enhancement, further accentuating intricate features for a highly detailed output (see an image (1514)). However, this also increases noise, leading to a more cluttered texture, making it suitable for applications prioritizing maximum detail, albeit with careful noise consideration.

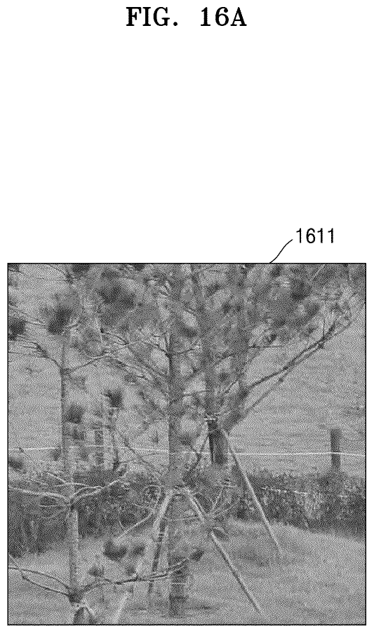

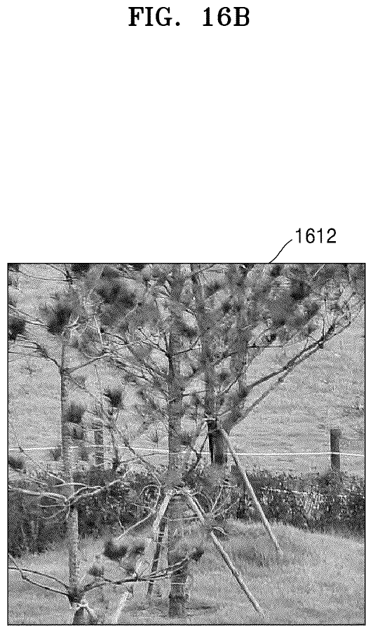

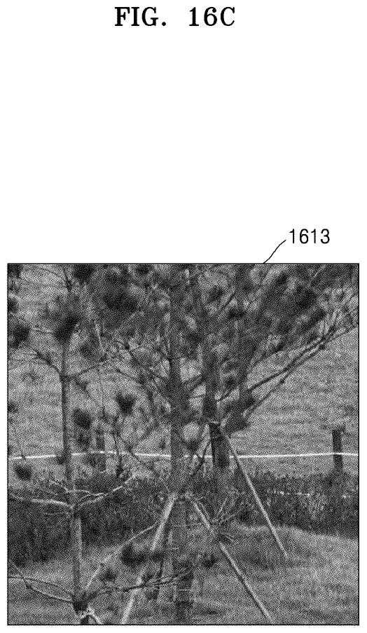

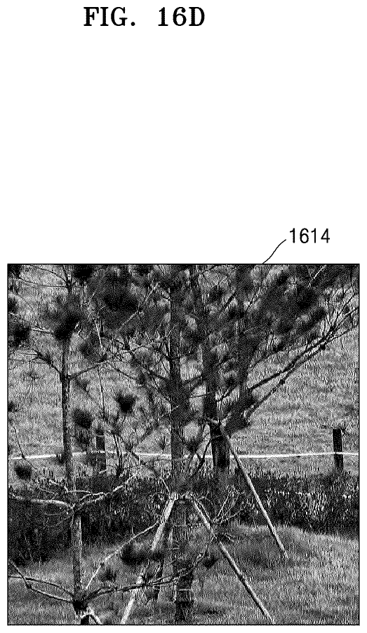

FIG. 16A to FIG. 16D illustrate the process of enhancing an image's naturalness, balancing between natural appearance and detail retention. The figures show how different weight assignments affect the final image, with W3>W2>W1.

FIG. 16A displays the original image (1611) with unaltered tones and colors, serving as a baseline. This stage highlights the sensor's limitations in capturing the full color spectrum as seen by the human eye.

In FIG. 16B, applying weight 1 (W1) makes subtle tone adjustments, slightly improving naturalness while preserving most details of the plant (see an image (1612)). This stage is ideal when detail retention is used, with minimal naturalness enhancement.

FIG. 16C applies weight 2 (W2), enhancing the image's vibrancy and realism (see an image (1613)). However, this results in some detail loss and slight oversaturation, illustrating the challenge of balancing naturalness with detail preservation.

FIG. 16D shows the application of weight 3 (W3), achieving peak naturalness with lifelike tones. This enhancement, however, further reduces detail and increases oversaturation, particularly affecting the plant (see an image (1614)). This stage emphasizes the trade-offs in naturalness enhancement, highlighting the need for an optimal balance between natural appearance and image clarity.

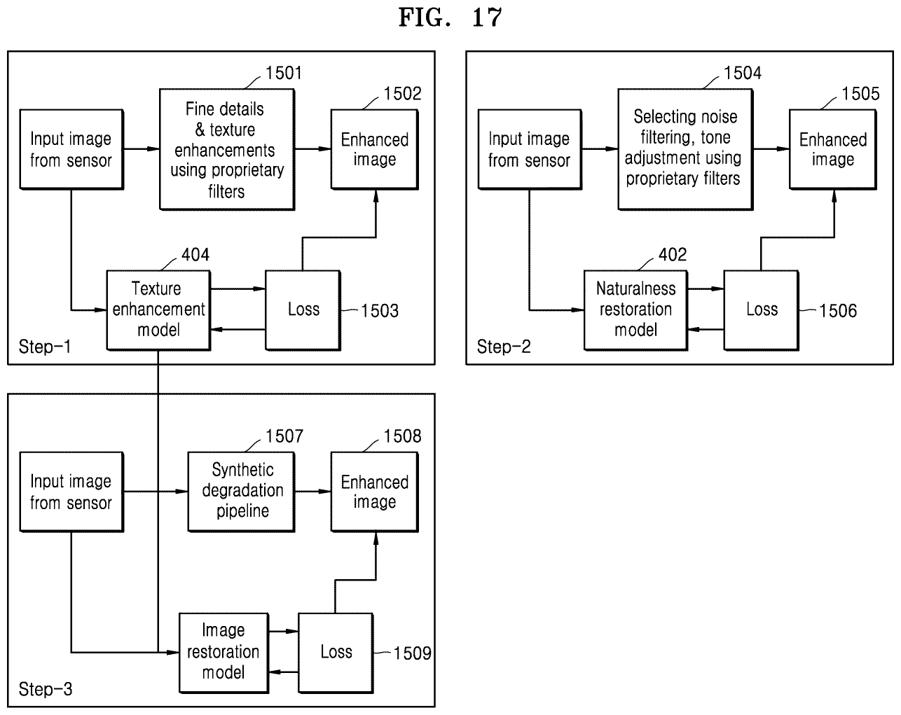

FIG. 17 is a block diagram that illustrates the training strategy for lightweight image restoration by the electronic device according to the embodiment disclosed herein. The first step (step-1) involves training the texture enhancement model (404) using sensor-specific data. The second step (step-2) involves training the natural enhancement model (402) using sensor-specific data, and the third step (step-3) involves training the lightweight image restoration/enhancement model using attention features from pre-trained enhancement and naturalness restoration models (402, 404).

At step 1, the texture enhancement model (404) is used to improve the image's texture. This process includes an input image from sensor, which acts as the initial raw image captured by the sensor and serves as the input to the texture enhancement model (404). The proprietary filters (1501) are then applied to extract fine details and significantly enhance the texture. The resulting output is the enhanced image (1502), indicating improvements in detail and texture fidelity. Further, a loss function (1503) evaluates the enhanced image's quality against predetermined target attributes, ensuring the model's effectiveness. The architecture of the texture enhancement model (404) employs convolutional layers that vary in size and depth to optimize performance. At step 1, the texture enhancement model (404) learns to refine textures over multiple iterations, enhancing patterns' regularity, improving fine details, and giving surfaces a more realistic feel. This step creates images that resonate more deeply with viewers, making them feel more authentic and visually appealing.

At step 2, the training of the natural enhancement model (402) utilizes sensor-specific data to enhance image quality. This process involves an input image captured from sensor, which acts as the initial raw image captured by the sensor and serves as the model's input. The proprietary filters (1504) in the naturalness restoration model (402) are utilized to perform tasks such as noise filtering, tone adjustment, preservation of natural grain, better lighting, and shadow details. These filters are used to enhance the image's overall visual quality, resulting in an enhanced image (1505) that captures the true essence of the scene. Further, the loss function (1506) is also integrated into this naturalness restoration model (402) to ensure that the model's outputs align closely with the features characteristic of natural images. This ensures that the naturalness restoration model (402) prioritizes elements like color fidelity and lighting accuracy. Through multiple training iterations, the naturalness restoration model (402) effectively learns to refine naturalness features. The naturalness restoration model (402) enhances aspects such as color richness, the accuracy of lighting and shadow interplay, and the management of noise patterns. Thus, the naturalness restoration model (402) significantly enhances the authenticity and visual appeal of images.

At step 3, the image restoration model of the lightweight image restoration engine (403) is trained using the input image from the sensor and the synthetic degradation pipeline (1507), which creates degraded versions of the images for training. The image restoration model focuses on general tasks such as denoising, deblurring, super-resolution, and detail enhancement. The image restoration model pairs these degraded images with their enhanced counterparts to learn how to restore and improve image quality. The training dataset for the image restoration model is sensor-agnostic, allowing the model to work with various camera systems. The outputs from both the naturalness restoration model (402) and texture enhancement models (404) are fed into the image restoration model, which utilizes an attention-based convolutional neural network to combine features. This integration ensures that the final output retains enhanced naturalness and texture, resulting in high-quality, lifelike images. Further, the output of the naturalness restoration model (402), the output of the texture enhancement (404), and output of image restoration models are fused together to create the final image. Further, the fusion is guided by scenario-based weighting, which takes into account various factors such as zoom level, lighting conditions, and scene characteristics. By considering these elements, the process ensures that the resulting images are texture-rich and natural-looking, optimized for the specific conditions in which they were captured. This approach results in high-quality images that truly reflect the scene's essence.

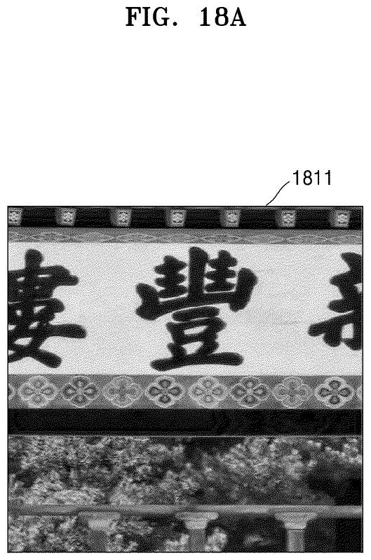

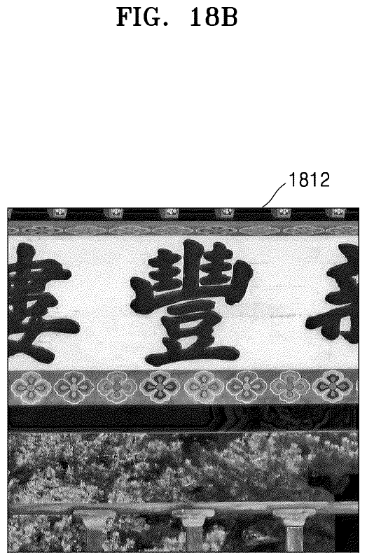

FIGS. 18A-18B illustrate the comparison between the input image and the output of the proposed model according to the embodiment disclosed herein. FIG. 18A illustrates the original input image representing the initial appearance of the wood design. The input image (1811) appears dull, with lighting resulting in a lack of vibrancy and exhibits oversaturation that flattens the texture. FIG. 18B illustrates the enhanced output generated by the proposed model, highlighting significant improvements in detail, lighting, texture richness, and overall visual appeal (see an image (1812)). The enhancements indicate the model's ability to restore and elevate the quality of the original image.

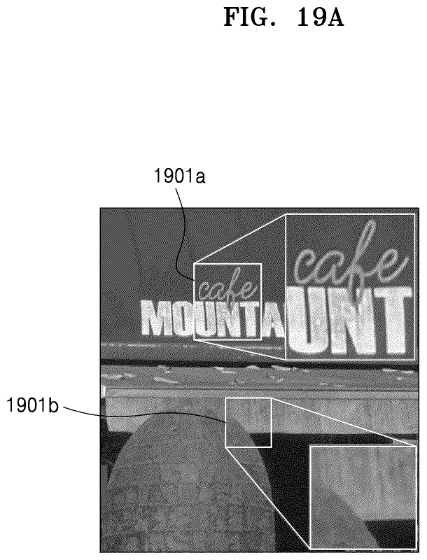

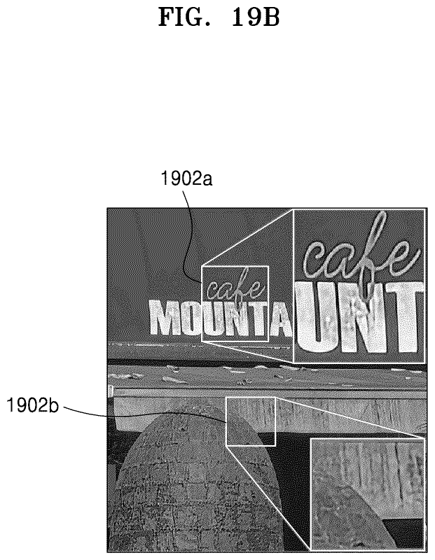

FIGS. 19A-19B illustrate the comparison between the input image and the output of the proposed model according to the embodiment disclosed herein. In FIG. 19A, the original input image is shown where the text (1901a) appears unnaturally enhanced and blurred, while the wall texture (1901b) looks flattened and lacks depth. FIG. 19B illustrates the enhanced output generated by the proposed model. In FIG. 19B, it is observed that the text (1902a) indicates significant texture enhancement, improving clarity and detail. The wall (1902b) indicates a grainy and coarse texture, representing a more natural enhancement that brings out the original characteristics of the surface.

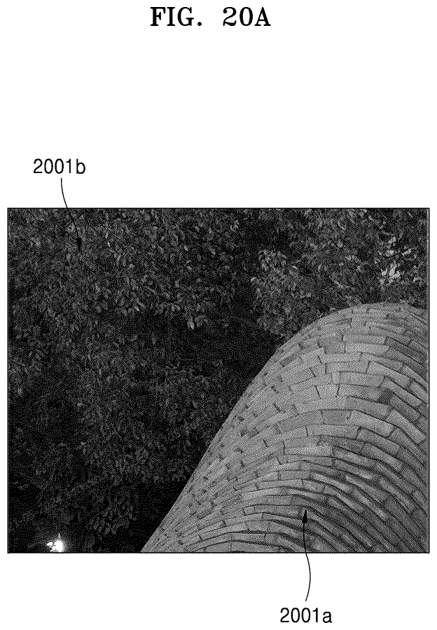

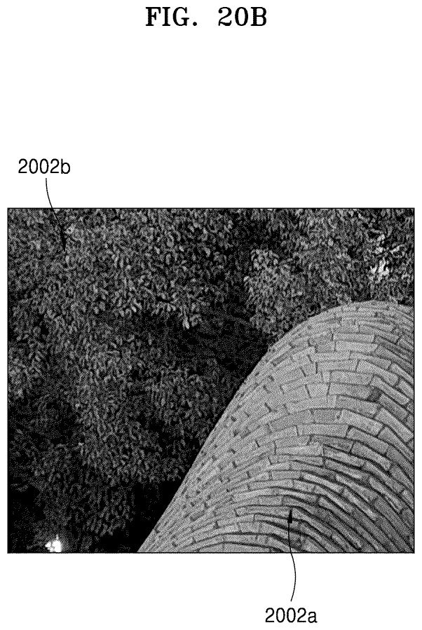

FIGS. 20A-20B illustrate the comparison between the input image and the output of the proposed model according to the embodiment disclosed herein. FIG. 20A discloses the original input image illustrating a flattened appearance of the brick structure (2001a) and dark lighting in the surrounding trees (2001b), which diminishes the overall visual appeal. FIG. 20B illustrates the enhanced output from the proposed model. The output images (brick-structured wall) (2002a) display significantly improved texture, enhancing the depth and detail of the bricks. Additionally, the lighting in the trees (2002b) has been enhanced, resulting in a brighter and more vibrant representation that better reflects the natural environment.

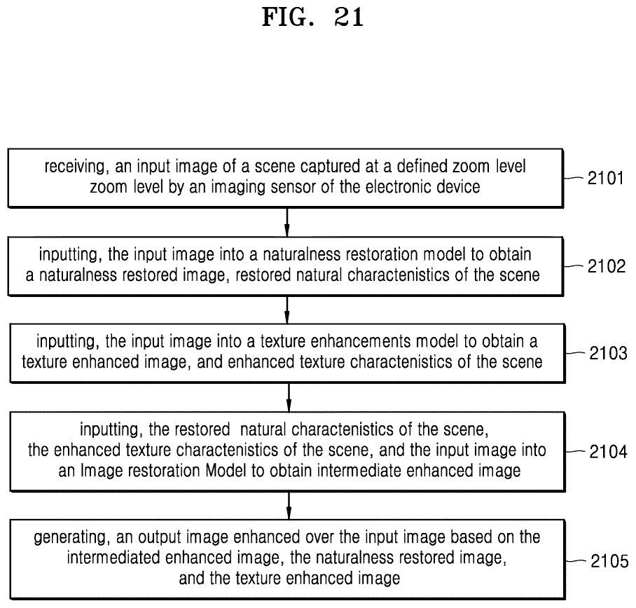

FIG. 21 is the flowchart that illustrates the working of the proposed model according to the embodiment disclosed herein. At operation (2101), the lightweight image restoration model receives the input image of the scene. The input image is captured at the defined zoom level by the imaging sensor of the electronic device. At operation (2102), the input image is passed into the naturalness restoration model (402) to obtain the naturalness restored image and restored natural characteristics of the scene. The naturalness restoration model extracts feature maps from the input image. The feature maps include the restored natural characteristics and information regarding one of sensor noise characteristics, lighting and shadow accuracy, and color fidelity. Further, the naturalness restoration model (402) reconstructs the naturalness restored image based on the feature maps and the targeted corrections in the input image. The naturalness restored image resembles the input image of the scene with enhanced naturalness and visual fidelity.

At operation (2103), the input image is passed to the texture enhancement model (404) to obtain the texture-enhanced image and enhanced texture characteristics of the scene. The texture enhancement model (404) extracts feature maps from the input image. The extracted feature maps include the enhanced texture characteristics regarding texture attributes. The texture attributes include the frequency of texture elements, the level of coarseness of fine details, homogeneity of patterns, and a level of surface roughness. Additionally, the texture enhancement model (404) improves the texture details in the input images by emphasizing fine details, contours, and texture patterns. This process enhances the visual and structural quality of the texture in the input image, resulting in the generation of a texture-enhanced image with enhanced texture details. The input, the restored natural characteristics of the scene, the enhanced texture characteristics of the scene, and the input image are fed into the or lightweight image restoration engine (403) to obtain the intermediate enhanced image at operation (2104). Then, the fusion unit (405) generates the output image at operation (2105) enhanced over the input image based on the intermediate enhanced image, the naturalness restored image, and the texture-enhanced image.

In an embodiment, the inputting the input image into the naturalness restoration model may comprise extracting first feature maps from the input image using the naturalness restoration model. The first feature maps may comprise the restored natural characteristics and information associated with at least one of sensor noise characteristics, lighting, shadow accuracy, or color fidelity. The inputting the input image into the naturalness restoration model may comprise may comprise applying targeted corrections in the input image for at least one of noise reduction, lighting adjustments, or color correction based on the first feature maps. The inputting may comprise reconstructing the naturalness restored image based on the first feature maps and the targeted corrections. The naturalness restored image resembles the input image of the scene with enhanced naturalness and visual fidelity. The naturalness restored image may be reconstructed with the enhanced naturalness and the visual fidelity based on information comprised in the first feature maps.

In an embodiment, inputting the input image into the texture enhancement model comprise extracting second feature maps from the input image by the texture enhancement model. The second feature maps comprise the enhanced texture characteristics associated with texture attributes. The texture attributes may comprise one or more of frequency of texture elements, a level of coarseness of fine details, homogeneity of patterns, or a level of surface roughness. The inputting may comprise enhancing texture details in the input image by accentuating at least one of fine details, contours, or texture patterns, and enhancing the second feature maps to improve a visual and structural quality of texture of the input image. The inputting may comprise generating the texture enhanced image comprising the enhanced texture details.

In an embodiment, the method may further comprise receiving the texture enhancement model subsequent to the texture enhancement model being trained. Training the texture enhancement model may comprise inputting a pair of images into a lightweight neural network. The pair of images may comprise a training image and a texture-enhanced image generated using filters to highlight and improve specific textural attributes in the training image. The lightweight neural network may comprise a plurality of convolutional layers with varying spatial dimensions and depths to process the training image. Training the texture enhancement model may comprise training the lightweight neural network using the pair of images, a set of filters, and a texture enhancement model dataset. The set of filters are configured to maintain a style consistency and a pixel-level accuracy in the output image. Training the texture enhancement model may comprise executing one or more learning iterations to enhance textures in the pair of images, and to improve a level of pattern regularity, a level fine detail coarseness, and a level of surface roughness. The texture enhancement model dataset is created by obtaining training images captured by a specific camera sensor for which the texture enhancement model is to be deployed. The texture enhancement model dataset is created by applying the set of filters to the training images. The set of filters are configured to improve a regularity and directionality of patterns in the images, increase a frequency and coarseness of existing fine details of the training images, and enhance a level of surface roughness of the training images. The texture enhancement model dataset is created by generating, based on an output from the set of filters, a dataset comprising images with enhanced texture elements and associated with the imaging sensor of the electronic device.

In an embodiment, the method may further comprise receiving the naturalness restoration model subsequent to the naturalness restoration model being trained. Training the naturalness restoration model may comprise inputting a pair of images into a lightweight neural network. The pair of images may comprise a training image and a naturalness enhanced image. The lightweight neural network may comprise a plurality of convolutional layers with varying spatial dimensions and depths to process training images. Training the naturalness restoration model may comprise executing one or more learning iterations to enhance naturalness features in the pair of images. The naturalness features may include at least of a level of color fidelity, a level of lighting accuracy, or a level of controlled noise patterns. The naturalness restoration model dataset is created by capturing training images using a specific camera sensor intended for deployment of the naturalness restoration model. The naturalness restoration model dataset is created by applying the filters to the training images. The filters may be configured to: perform selective denoising on the training images to reduce noise while preserving image detail; enhance natural grain in the training images to retain characteristics specific to the imaging sensor of the electronic device; and improve overall detail and clarity of the training images. The naturalness restoration model dataset is created by generating, based on an output from the filters, a dataset comprising images with enhanced naturalness elements and associated with the imaging sensor of the electronic device.

In an embodiment, the method may further comprise receiving the image restoration model subsequent to the image restoration model being trained. Training the image restoration model may comprise generating degraded versions of training images by passing training images through a synthetic degradation pipeline. The synthetic degradation pipeline may be created by randomly varying degradation parameters to simulate real-world degradation scenarios including at least one of denoising operations, deblurring operations, super-resolution operations, or enhancement tasks operations. Training the image restoration model may comprise mapping the degraded versions of training images with associated enhanced counterparts to form a training dataset for the image restoration model. Training the image restoration model may comprise fusing third feature maps obtained from an attention-based convolutional neural network (CNN) with output images obtained from the naturalness restoration model and the texture enhancement model. The attention-based CNN may be trained based on a sensor-agnostic dataset comprising images captured from a wide range of devices under various lighting conditions with different color profiles and resolutions. The degraded versions of training images may be created by applying a combination of at least one of the denoising operations, the deblurring operations, the super-resolution operations, or the enhancement tasks operations.

In an embodiment, generating the output image may comprise fusing the intermediate enhanced image, the naturalness restored image, and the texture enhanced image by applying scenario-based weighting. The scenario-based weighting may be determined by factors including at least one of the pre-defined zoom level of the input image, lighting conditions of the input image, and features of the input image.

The embodiments of the present disclosure produce texture-rich, naturally appealing images at a defined zoom in the capture pipeline. It enables high-quality camera capture for faraway shots (10×-100×) in mobile devices. The high zoom captured images have better texture detail retention, grainy sensor noise, and natural scene tone with enhanced resolution, deblurring, and noise reduction.

The various actions, acts, blocks, steps, or the like in the method is performed in the order presented, in a different order or simultaneously. Further, in some embodiments, some of the actions, acts, blocks, steps, or the like are omitted, added, modified, skipped, or the like without departing from the scope of the proposed method.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

What is claimed is:

1. A method for lightweight image restoration, the method executed by at least one processor of an electronic device, the method comprising:
receiving an input image of a scene captured at a pre-defined zoom level by an imaging sensor of the electronic device;
inputting the input image into a naturalness restoration model to obtain a naturalness restored image and restored natural characteristics of the scene;
inputting the input image into a texture enhancement model to obtain a texture enhanced image and enhanced texture characteristics of the scene;
inputting the restored natural characteristics of the scene, the enhanced texture characteristics of the scene, and the input image into an image restoration model to obtain an intermediate enhanced image corresponding to the input image; and
generating, using a fusion unit, an output image that is an enhanced version of the input image based on the intermediate enhanced image, the naturalness restored image, and the texture enhanced image.

2. The method as claimed in claim 1, wherein the inputting the input image into the naturalness restoration model comprises:
extracting first feature maps from the input image using the naturalness restoration model, wherein the first feature maps comprise the restored natural characteristics and information associated with at least one of sensor noise characteristics, lighting, shadow accuracy, or color fidelity;
applying targeted corrections in the input image for at least one of noise reduction, lighting adjustments, or color correction based on the first feature maps; and
reconstructing the naturalness restored image based on the first feature maps and the targeted corrections, wherein the naturalness restored image resembles the input image of the scene with enhanced naturalness and visual fidelity.

3. The method as claimed in claim 2, wherein the naturalness restored image is reconstructed with the enhanced naturalness and the visual fidelity based on the information comprised in the first feature maps.

4. The method as claimed in claim 1, wherein the inputting the input image into the texture enhancement model comprises:
extracting second feature maps from the input image by the texture enhancement model, wherein the second feature maps comprise the enhanced texture characteristics associated with texture attributes, the texture attributes comprising one or more of frequency of texture elements, a level of coarseness of fine details, homogeneity of patterns, or a level of surface roughness;
enhancing texture details in the input image by accentuating at least one of fine details, contours, or texture patterns, and enhancing the second feature maps to improve a visual and structural quality of texture of the input image;
generating the texture enhanced image comprising the enhanced texture details.

5. The method as claimed in claim 1, further comprising receiving the texture enhancement model subsequent to the texture enhancement model being trained, wherein training the texture enhancement model comprises:
inputting a pair of images into a lightweight neural network, wherein the pair of images comprises a training image and a texture-enhanced image generated using filters to highlight and improve specific textural attributes in the training image, wherein the lightweight neural network comprises a plurality of convolutional layers with varying spatial dimensions and depths to process the training image;
training the lightweight neural network using the pair of images, a set of filters, and a texture enhancement model dataset, wherein the set of filters are configured to maintain a style consistency and a pixel-level accuracy in the output image; and
executing one or more learning iterations to enhance textures in the pair of images, and to improve a level of pattern regularity, a level fine detail coarseness, and a level of surface roughness.

6. The method as claimed in claim 5, wherein the texture enhancement model dataset is created by:
obtaining training images captured by a specific camera sensor for which the texture enhancement model is to be deployed;
applying the set of filters to the training images, wherein the set of filters are configured to improve a regularity and directionality of patterns in the images, increase a frequency and coarseness of existing fine details of the training images, and enhance a level of surface roughness of the training images; and
generating, based on an output from the set of filters, a dataset comprising images with enhanced texture elements and associated with the imaging sensor of the electronic device.

7. The method as claimed in claim 1, further comprising receiving the naturalness restoration model subsequent to the naturalness restoration model being trained, wherein training the naturalness restoration model comprises:
inputting a pair of images into a lightweight neural network, wherein the pair of images comprises a training image and a naturalness enhanced image, wherein the lightweight neural network comprises a plurality of convolutional layers with varying spatial dimensions and depths to process training images;
training the lightweight neural network using the pair of images, a set of filters, and a naturalness restoration dataset, wherein the set of filters are configured to maintain a style consistency and a pixel-level accuracy in the output image;
executing one or more learning iterations to enhance naturalness features in the pair of images, wherein the naturalness features include at least of a level of color fidelity, a level of lighting accuracy, or a level of controlled noise patterns.

8. The method as claimed in claim 7, wherein the naturalness restoration model dataset is created by:
capturing training images using a specific camera sensor intended for deployment of the naturalness restoration model;
applying the filters to the training images, wherein the filters are configured to: perform selective denoising on the training images to reduce noise while preserving image detail; enhance natural grain in the training images to retain characteristics specific to the imaging sensor of the electronic device; and improve overall detail and clarity of the training images; and
generating, based on an output from the filters, a dataset comprising images with enhanced naturalness elements and associated with the imaging sensor of the electronic device.

9. The method as claimed in claim 1, further comprises receiving the image restoration model subsequent to the image restoration model being trained, wherein training the image restoration model comprises:
generating degraded versions of training images by passing training images through a synthetic degradation pipeline, wherein the synthetic degradation pipeline is created by randomly varying degradation parameters to simulate real-world degradation scenarios including at least one of denoising operations, deblurring operations, super-resolution operations, or enhancement tasks operations;
mapping the degraded versions of training images with associated enhanced counterparts to form a training dataset for the image restoration model; and
fusing third feature maps obtained from an attention-based convolutional neural network (CNN) with output images obtained from the naturalness restoration model and the texture enhancement model.

10. The method as claimed in claim 9 wherein the attention-based CNN is trained based on a sensor-agnostic dataset comprising images captured from a wide range of devices under various lighting conditions with different color profiles and resolutions.

11. The method as claimed in claim 9, wherein the degraded versions of training images are created by applying a combination of at least one of the denoising operations, the deblurring operations, the super-resolution operations, or the enhancement tasks operations.

12. The method as claimed in claim 1, wherein the generating, using a fusion unit, the output image comprises:
fusing the intermediate enhanced image, the naturalness restored image, and the texture enhanced image by applying scenario-based weighting, wherein the scenario-based weighting is determined by factors including at least one of the pre-defined zoom level of the input image, lighting conditions of the input image, and features of the input image.

13. An electronic device, for enhancing captured image by using an imaging sensor comprising:
memory;
at least one processor coupled to the memory; and
a lightweight image restoration controller, coupled to the processor, wherein the lightweight image restoration controller is configured to:
receive an input image of a scene captured at a pre-defined zoom level by an imaging sensor of the electronic device;
input the received input image into a naturalness restoration model to obtain a naturalness restored image, and restored natural characteristics of the scene;
input the input image into a texture enhancement model to obtain a texture enhanced image, and enhanced texture characteristics of the scene;
input the restored natural characteristics of the scene, the enhanced texture characteristics of the scene, and the input image into an image restoration model to obtain an intermediate enhanced image corresponding to the input image; and
generate, using a fusion unit, an output image that is an enhanced version of the input image based on the intermediate enhanced image, the naturalness restored image, and the texture enhanced image.

14. The electronic device of claim 13, wherein the inputting the input image into the naturalness restoration model comprises:
extracting first feature maps from the input image using the naturalness restoration model, wherein the first feature maps comprise the restored natural characteristics and information associated with at least one of sensor noise characteristics, lighting, shadow accuracy, or color fidelity;
applying targeted corrections in the input image for at least one of noise reduction, lighting adjustments, or color correction based on the first feature maps; and
reconstructing the naturalness restored image based on the first feature maps and the targeted corrections, wherein the naturalness restored image resembles the input image of the scene with enhanced naturalness and visual fidelity.

15. The electronic device of claim 14, wherein the naturalness restored image is reconstructed with the enhanced naturalness and the visual fidelity based on the information comprised in the first feature maps.

16. The electronic device of claim 13, wherein the inputting the input image into the texture enhancement model comprises:
extracting second feature maps from the input image by the texture enhancement model, wherein the second feature maps comprise the enhanced texture characteristics associated with texture attributes, the texture attributes comprising one or more of frequency of texture elements, a level of coarseness of fine details, homogeneity of patterns, or a level of surface roughness;
enhancing texture details in the input image by accentuating at least one of fine details, contours, and texture patterns, or enhancing the second feature maps to improve a visual and structural quality of texture of the input image;
generating the texture enhanced image comprising the enhanced texture details.

17. The electronic device of claim 13, wherein the lightweight image restoration controller is further configured to receive the texture enhancement model subsequent to the texture enhancement model being trained, and wherein training the texture enhancement model comprises:
inputting a pair of images into a lightweight neural network, wherein the pair of images comprises a training image and a texture-enhanced image generated using filters to highlight and improve specific textural attributes in the training image, wherein the lightweight neural network comprises a plurality of convolutional layers with varying spatial dimensions and depths to process the training image;
training the lightweight neural network using the pair of images, a set of filters, and a texture enhancement model dataset, wherein the set of filters are configured to maintain a style consistency and a pixel-level accuracy in the output image; and
executing one or more learning iterations to enhance textures in the pair of images, and to improve a level of pattern regularity, a level fine detail coarseness, and a level of surface roughness.

18. The electronic device of claim 13, wherein the lightweight image restoration controller is further configured to receive the naturalness restoration model subsequent to the naturalness restoration model being trained, wherein training the naturalness restoration model comprises:
inputting a pair of images into a lightweight neural network, wherein the pair of images comprises a training image and a naturalness enhanced image, wherein the lightweight neural network comprises a plurality of convolutional layers with varying spatial dimensions and depths to process training images;
training the lightweight neural network using the pair of images, a set of filters and a naturalness restoration dataset, wherein the set of filters are configured to maintain a style consistency and a pixel-level accuracy in the output image;
executing one or more learning iterations to enhance naturalness features in the pair of images, wherein the naturalness features include at least of a level of color fidelity, a level of lighting accuracy, or a level of controlled noise patterns.

19. The electronic device of claim 13, wherein the lightweight image restoration controller is further configured to receive the image restoration model subsequent to the image restoration model being trained, wherein training the image restoration model comprises:
generating degraded versions of training images by passing training images through a synthetic degradation pipeline, wherein the synthetic degradation pipeline is created by randomly varying degradation parameters to simulate real-world degradation scenarios including at least one of denoising operations, deblurring operations, super-resolution operations, or enhancement tasks operations;
mapping the degraded versions of training images with associated enhanced counterparts to form a training dataset for the image restoration model; and
fusing third feature maps obtained from an attention-based convolutional neural network (CNN) with output images obtained from the naturalness restoration model and the texture enhancement model.

20. A non-transitory computer-readable medium storing one or more instructions, the one or more instructions, when executed by at least one processor, cause the at least one processor to:
receive an input image of a scene captured at a pre-defined zoom level by an imaging sensor of an electronic device;
input the received input image into a naturalness restoration model to obtain a naturalness restored image, and restored natural characteristics of the scene;
input the input image into a texture enhancement model to obtain a texture enhanced image, and enhanced texture characteristics of the scene;
input the restored natural characteristics of the scene, the enhanced texture characteristics of the scene, and the input image into an image restoration model to obtain an intermediate enhanced image corresponding to the input image; and
generate, using a fusion unit, an output image that is an enhanced version of the input image based on the intermediate enhanced image, the naturalness restored image, and the texture enhanced image.
